(19) United States
(12) Patent Application Publication
(10) Pub. No.: US 2007/0090867 A1
(43) Pub. Date: Apr. 26, 2007

(54) Clock generation circuit and method of generating clock signals

(75) Inventor: Kyu-hyoun Kim, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/472,322

(22) Filed: Jun. 22, 2006

(30) Foreign Application Priority Data
Oct. 26, 2005 (KR) P2005-101497

(51) Int. Cl. G06F 1/04

(52) U.S. Cl. 327/291

(57) ABSTRACT

Clock generation circuit and method of generating clock signals. The clock generation circuit includes an inverter directly receiving an external clock signal and outputting an inverted external clock signal, M (where M is an integer ≧1) loop circuits arranged in series, the first loop circuit receiving the inverted external clock signal, each of the N loop circuits having n (where n is an integer ≧2) nodes, each of the M−1 loop circuits generating n intermediate internal clock signals, each at a corresponding one of the n nodes, wherein a frequency of the n intermediate internal clock signals is a multiple of a frequency of the external clock signal and the inverted external clock signal; and n sets of inverters, each including M−1 inverters connected in series, each of the M−1 inverters receiving a corresponding intermediate internal clock signal from a previous loop circuit and outputting a corresponding intermediate internal clock signal to a next loop circuit.

### PRIORITY STATEMENT

This U.S. non-provisional application claims priority under 35 U.S.C. § 119 to Korean Patent Application No. 2005-0101497, filed on Oct. 26, 2005, the entire contents of which are incorporated by reference.

### BACKGROUND OF THE INVENTION

FIG. 1A illustrates a conventional phase locked loop, which may include a phase detector (PD) 10, a charge pump (CP) 12, a loop filter (LP) 14, a voltage controlled oscillator (VCO) 16, one or more dividers 18-1, 18-2, and/or one or more dividers 20.

The phase detector (PD) 10 may receive an external clock signal ECLK and generate an UP or DN signal in response to a phase difference between the external clock signal ECLK and a feedback clock signal DCLK. When the phase of the external input signal ECLK leads that of the feedback clock signal DCLK, the UP signal is activated. When the phase of ECLK lags that of DCLK, the DN signal is activated.

The charge pump (CP) 12 and/or the loop filter (LP) 14 may increase the level of a control voltage Vc, in response to the activated UP signal and may decrease the level of the control voltage Vc, in response to the activated DN signal.

For example, when the frequency of ECLK is 1 GHz, in order to acquire one or more final internal clocks of 2 GHz frequency, a conventional voltage controlled oscillator (VCO) 16 may generate two clock signals CLK0 and CLK180, each with a frequency of 4 GHz. The divider 18-1 may divide the clock signal CLK0 to generate two clock signals ICLK0, ICLK180, each with a frequency of 2 GHz. The divider 18-2 may divide the inverted clock signal CLK180 to generate two clock signals ICLK90, ICLK270, each with a frequency of 2 GHz.

The divider 20 may receive one of the clock signals ICLK0, ICLK180, ICLK90 and ICLK270 and output the feedback clock signal DCLK, with a frequency of 1 GHz, which equals the frequency of ECLK.

That is, in order to acquire final internal clock signals ICLK0, ICLK180, ICLK90 and ICLK270 having a higher frequency than that of ECLK, the divider 20 is necessary. In other words, when a PLL does not include the divider 20, the frequencies of the final internal clocks ICLK0˜ICLK270 are not equal to the frequency of external input clock ECLK.

As a result, a problem with conventional phase lock loops is that when a power supply voltage is affected by noise, this noise may result in the output final clock signals ICLK0, ICLK180, ICLK90 and ICLK270 including error components. One reason for this is because the control voltage Vc may be easily varied by an unstable power supply voltage. The frequency of the VCO 16 output clock signals is dependent on the voltage level of the control voltage Vc. In addition, conventional PLLs may have a disadvantage that they require a fairly long time until locking operation is completed.

FIG. 1B illustrates another conventional phase locked loop. The conventional phase locked loop of FIG. 1B includes some of the same elements as that of FIG. 1A. In addition to one or more dividers 18-1, 18-2, and one or more dividers 20, the conventional phase locked loop of FIG. 1B may further include one or more dividers 18-3, 18-4, 18-5, and 18-6. As shown, the frequency of each of CLK and CLKB is eight times higher than that of ECLK while the frequency of each of iCLK0˜iCLK270 is four times higher than that of ECLK. Further, the frequency of each of ICLK0˜ICLK315 is two times higher than that of ECLK.

As an example, if the frequency of ECLK is 1 GHz, the frequency of CLK and CLKB is 8 GHz, the frequency of iCLK0˜iCLK270 is 4 GHz, and the frequency of ICLK0˜ICLK315 is 2 GHz. Under low power supply voltage conditions (for example, less than 2VDD), a conventional VCO 16 cannot generate the output clocks CLK and CLKB with a frequency of 8 GHz.

Similar to the phase locked loop of FIG. 1A, in the phase locked loop of FIG. 1B, the frequency of the VCO 16 output clock signals is dependent on the voltage level of the control voltage Vc. Also, the conventional PLL of FIG. 1B may have a disadvantage that it requires a fairly long time until locking operation is completed.

FIG. 2 illustrates a conventional voltage controlled oscillator, for example, VCO 16 of FIG. 1. The conventional voltage controlled oscillator 16 may include a first ring oscillator 16-1 including one or more inverters 11, 12, 13, formed in a loop configuration, a second ring oscillator 16-2 including one or more inverters I4, I5, I6, formed in a loop configuration (for example, the same configuration as the first ring oscillator 16-1) and a latch circuit 16-3 including one or more inverters 17,18, for latching CLK and CLKB.

The frequency of the output clock CLK/CLKB may be controlled in response of the level of the control voltage Vc. When the level of the control voltage Vc is increased, the frequency of the output clock CLK/CLKB may be increased. When the level of the control voltage Vc is decreased, the frequency of the output clock CLK/CLKB may be decreased.

FIG. 3 illustrates a conventional delay lock loop, which may include a phase detector (PD) 30, a charge pump (CP) 32, a loop filter (LP) 34, a voltage control delay line (VCDL) 36, a selection and phase interpolator 38, a control circuit (CC) 32, and a phase detector (PD) 40. As shown in FIG. 3, the voltage control delay line (VCDL) 36 generates a plurality of clock signals CLK0, CLK90, CLK180, CLK270 having an identical phase different between adjacent clock signals and delayed by a desired time from the external clock signal ECLK in response to the control voltage Vc. In the example illustrated in FIG. 3, the VCDL 36 generates four clock signals.

The selection and phase interpolation circuit 38 generates final internal clock signals ICLK0, ICLK90, ICLK180, and ICLK270 in response to a control signal CON after selecting two input clock signals and interpolating phases between the selected two clock signals. The control circuit (CC) 42 generates the control signal CON in response to the UP or DN signal.

The conventional delay lock loop illustrated in FIG. 3 is a dual loop configuration, the first loop being formed by the phase detector (PD) 30, the charge pump (CP) 32, the loop filter (LP) 34, and the voltage control delay line (VCDL) 36 and the second loop being formed by the selection and phase interpolation circuit 38, the control circuit (CC) 32, and the phase detector (PD) 40. One problem with the conventional delay lock loop of FIG. 3 is that loop locking time is relative long.

FIG. 4 illustrates an example implementation of the voltage control delay line (VCDL) 36 of FIG. 3. As shown in FIG. 4, the voltage control delay line (VCDL) 36 may include four delay cells D1-D4. Each of the delay cells D1-D4 may output a corresponding clock signal CLK0-CLK270. The voltage control delay line (VCDL) 36 outputs a feedback clock signal FCLK, delayed from the external clock signal ECLK, in response to the control voltage Vc.

As set forth above, the control voltage Vc of a DLL may be easily modified by an unstable power supply voltage. As a result, the frequency of the voltage control delay line VCDL 36 output clock signals (CLK0-CLK270 and FCLK) are also variable, depending on the voltage level of the control voltage Vc. If the control voltage Vc includes noise, the output clock signals (CLK0-CLK270 and FCLK will contain errors, for example, phase errors. In addition, as mentioned above, the conventional DLL has a disadvantage in that the loop locking time is relatively long.

### SUMMARY OF THE INVENTION

Example embodiments of the present invention are directed to clock generation circuit, methods of generating clock signals, and methods of locking the phase of a feedback clock signal to an external clock signal.

Example embodiments of the present invention are directed to multiphase clock generators including clock generation circuits and memory devices including multiphase clock generators.

Example embodiments of the present invention are directed to memory systems and methods of writing data to and reading data from a memory, including a plurality of memory devices.

Example embodiments of the present invention are directed to clock generation circuits, multiphase clock generators, and memory devices, which include a hyper ring oscillator.

Example embodiments of the present invention are directed to clock generation circuits, multiphase clock generators, and memory devices, which include one or more loop circuits.

Example embodiments of the present invention are directed to clock generation circuits, multiphase clock generators, and memory devices, which require a reduced time until locking operation is completed.

Example embodiments of the present invention are directed to clock generation circuits, multiphase clock generators, and memory devices, which are less sensitive to power supply voltage fluctuations.

Example embodiments of the present invention are directed to clock generation circuits which directly receive an external clock signal.

In an example embodiment of the present invention, a clock generation circuit may include an inverter directly receiving an external clock signal and outputting an inverted external clock signal, M (where M is an integer ≧1) loop circuits arranged in series, the first loop circuit receiving the inverted external clock signal, each of the N loop circuits having n (where n is an integer ≧2) nodes, each of the M−1 loop circuits generating n intermediate internal clock signals, each at a corresponding one of the n nodes, wherein a frequency of the n intermediate internal clock signals is a multiple of a frequency of the external clock signal and the inverted external clock signal, and n sets of inverters, each including M−1 inverters connected in series, each of the M−1 inverters receiving a corresponding intermediate internal clock signal from a previous loop circuit and outputting a corresponding intermediate internal clock signal to a next loop circuit.

In another example embodiment of the present invention, the M loop circuits include a hyper ring oscillator.

In another example embodiment of the present invention, each of n sets of inverters includes M inverters connected in series and the clock generation circuit further includes an (M+1)th loop circuit, in series with the M loop circuits, the (M+1)th loop circuit having n nodes, each receiving a corresponding intermediate internal clock signal from each of the Mth inverters and generating n internal clock signals, each at a corresponding one of the n nodes.

In another example embodiment of the present invention, each of the (M+1)th loop circuits includes a plurality of loops.

In another example embodiment of the present invention, each of the (M+1)th loop circuits includes a single loop.

In another example embodiment of the present invention, n is selected from the group consisting of 4, 5, 6, 8, 9, 10, 12, 15, and 18.

In another example embodiment of the present invention, each of n sets of inverters includes M inverters connected in series, the clock generation circuit further including an (M+1)th loop circuit and an (M+2)th loop circuit and an (M+2)th set of inverters, the (M+1)th loop circuit and the (M+2)th loop circuit in series with the M loop circuits and in parallel with each other, the (M+1)th loop circuit having n nodes, some receiving a corresponding intermediate internal clock signals from the Mth inverters, the (M+2)th loop circuit having n nodes, some receiving a corresponding intermediate internal clock signals from the Mth inverters generating n internal clock signals, each at a corresponding one of the n nodes, a first group of n inverters, each receiving a corresponding intermediate internal clock signal from the (M+1)th loop circuit; a second group of n inverters, each receiving a corresponding intermediate internal clock signal from the (M+2)th loop circuit; and a third group of n inverters, each receiving outputs from the corresponding inverters from the first group of n inverters and the second group of n inverters and generating n internal clock signals.

In another example embodiment of the present invention, a memory device includes a memory cell array, a multiphase clock generator receiving an external clock signal and a feedback clock signal and comprising at least a clock generator circuit directly generating at least n (where n is an integer ≧2) internal clock signals, a control signal generator circuit for receiving the at least n internal clock signals and generating p control signals (where p is an integer ≧2), at least one serial to parallel converter, for receiving a serial bit stream bits and converting the serial bit stream into a parallel bit stream that can be written to the memory cell array, in response to each of the p control signals, and at least one parallel to serial converter, for receiving a parallel bit stream from the memory cell array and converting the parallel bit stream into a serial bit stream, in response to each of the p control signals.

In another example embodiment of the present invention, a method of generating n internal clock signals (where n is an integer ≧2), includes directly receiving an external clock signal and inverting the external clock signal, generating n intermediate internal clock signals from the inverted external clock signal, phase interpolating the n intermediate internal clock signals M times (where M is an integer ≧1) to generate the n internal clock signals.

In another example embodiment of the present invention, a method of locking the phase of a feedback clock signal to an external clock signal includes receiving the external clock signal and the feedback clock signal, outputting an up signal when a phase of the external clock signal leads a phase of the feedback clock signal and outputting a down signal when the phase of the external clock signal lags the phase of the feedback clock signal, generating at least one control signal in response to the up signal and the down signal, and directly generating at least n (where n is an integer ≧4) internal clock signals, the at least one control signal controlling a phase change of at least one of the n internal clock signals, and generating the feedback clock signal from at least one of the n internal clock signals.

### BRIEF DESCRIPTION OF THE DRAWINGS

The present invention will become more fully understood from the detailed description of example embodiments provided below and the accompanying drawings, which are given for purposes of illustration only, and thus do not limit the invention.

FIG. 1A illustrates a conventional phase locked loop.

FIG. 1B illustrates another conventional phase locked loop.

FIG. 2 illustrates a conventional voltage controlled oscillator.

FIG. 3 illustrates a conventional delay locked loop.

FIG. 4 illustrates an example implementation of the conventional voltage control delay line (VCDL) of FIG. 3

FIG. 5A illustrates a clock generation circuit in accordance with an example embodiment of the present invention, where N=4.

FIG. 5B is an example equivalent diagram of the clock generation circuit of FIG. 5A.

FIG. 6A illustrates a clock generation circuit in accordance with another example embodiment of the present invention, where N=4.

FIG. 6B is an example equivalent diagram of the clock generation circuit of FIG. 6A.

FIG. 7A illustrates a clock generation circuit, with a single loop or latch configuration, in accordance with another example embodiment of the present invention, where N=4.

FIG. 7B is an example equivalent diagram of the clock generation circuit of FIG. 7A.

FIG. 8 is an example equivalent diagram of a clock generation circuit in accordance with another example embodiment of the present invention, where N=5.

FIG. 9 is an example equivalent diagram of a clock generation circuit, with a latch configuration, in accordance with another example embodiment of the present invention, where N=5.

FIG. 10 is an example equivalent diagram of a clock generation circuit in accordance with another example embodiment of the present invention, where N=6.

FIG. 11 is an example equivalent diagram of a clock generation circuit, with a latch configuration, in accordance with another example embodiment of the present invention, where N=6.

FIG. 12 is an example equivalent diagram of a loop circuit in accordance with another example embodiment of the present invention.

FIG. 13 illustrates a multiphase clock generator in accordance with an example embodiment of the present invention.

FIG. 14A illustrates a multiphase clock generator in accordance with another example embodiment of the present invention.

FIG. 14B illustrates a multiphase clock generator in accordance with another example embodiment of the present invention.

FIG. 15A illustrates a multiphase clock generator in accordance with another example embodiment of the present invention.

FIG. 15B illustrates a multiphase clock generator in accordance with another example embodiment of the present invention.

FIG. 16 illustrates a phase detector in accordance with another example embodiment of the present invention.

FIGS. 17A-17D illustrate a selection and phase interpolation circuit in accordance with another example embodiment of the present invention.

FIG. 17E illustrates the relationship between various phases of clock signals for example combinations of control values in accordance with an example embodiment of the present invention.

FIG. 18 illustrates a control circuit in accordance with an example embodiment of the present invention.

FIG. 19 illustrates a weight control generator in accordance with an example embodiment of the present invention.

FIG. 20 illustrates a selection control signal generator in accordance with an example embodiment of the present invention.

FIG. 21 illustrates a charge pump and a loop filter in accordance with another example embodiment of the present invention.

FIG. 22 illustrates a voltage controlled delay line (VCDL) in accordance with an example embodiment of the present invention.

FIG. 23 illustrates a memory system including a multiphase clock generator in accordance with an example embodiment of the present invention.

FIG. 24 illustrates a memory device including a multiphase clock generator in accordance with an example embodiment of the present invention.

It should be noted that these Figures are intended to illustrate the general characteristics of methods and devices of example embodiments of this invention, for the purpose of the description of such example embodiments herein. These drawings are not, however, to scale and may not precisely reflect the characteristics of any example embodiment, and should not be interpreted as defining or limiting the range of values or properties of example embodiments within the scope of this invention.

### DETAILED DESCRIPTION OF EXAMPLE EMBODIMENTS

Various example embodiments of the present invention will now be described more fully with reference to the accompanying drawings in which some example embodiments of the invention are shown.

Detailed illustrative embodiments of the present invention are disclosed herein. However, specific structural and functional details disclosed herein are merely representative for purposes of describing example embodiments of the present invention. This invention may, however, be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. or numbers 1, 2, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the description. For example, two functions/acts described in succession may in fact be executed substantially concurrently or may sometimes be executed in the reverse order, depending upon the functionality/acts involved.

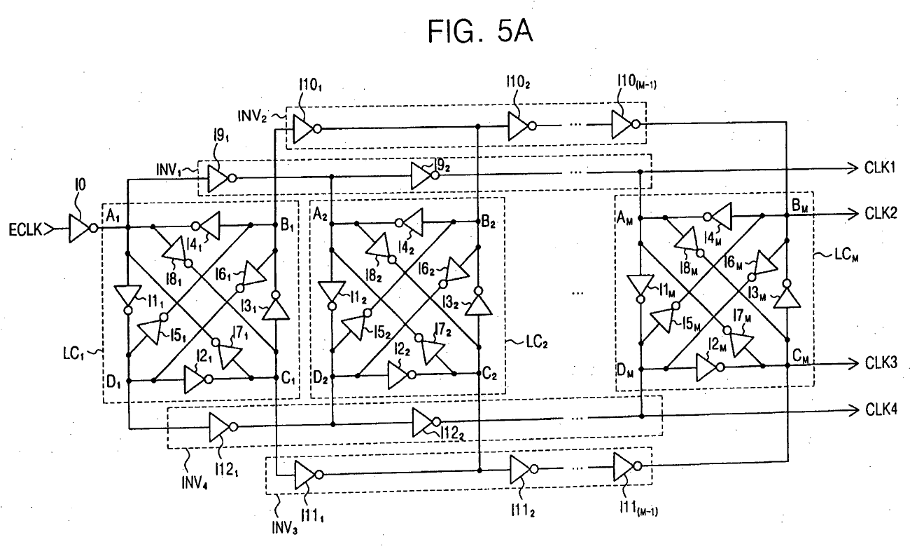

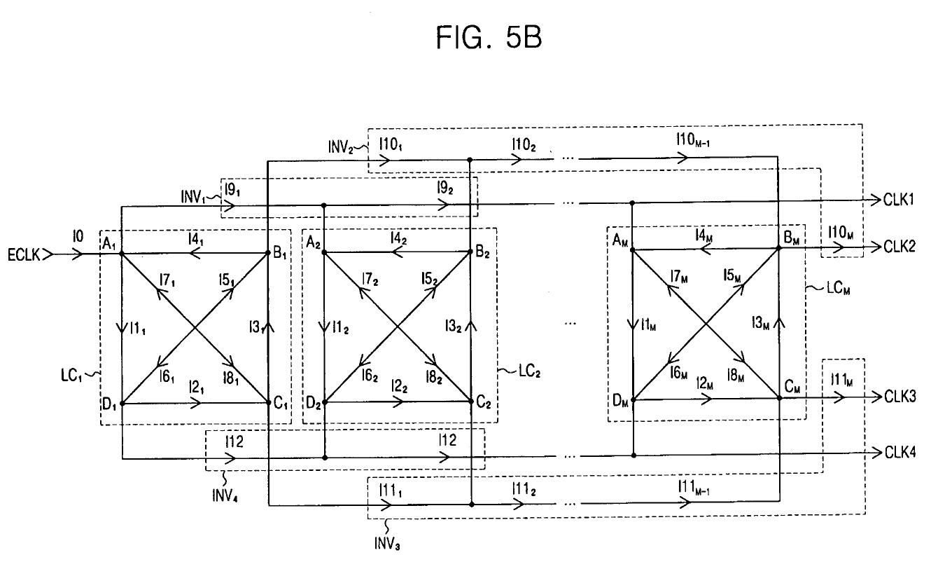

FIG. 5A illustrates a clock generation circuit in accordance with an example embodiment of the present invention, which includes an inverter IO, M (where M is an integer ≧1) loop circuits LC_{1 . . . M} arranged in series and N (where N is an integer ≧2) sets of inverters INV_{1 . . . N}.

As shown in FIG. 5A, each of the loop circuits LC_{1 . . . M} may include N (where N is an integer ≧2) nodes, where the number of nodes is equal to the number of sets of inverters INV_{1 . . . N}. In the example embodiment shown in FIG. 5A, N=4.

Each of the N sets of inverters INV_{1 . . . N} includes M−1 inverters, where M is the number of loop circuits LC_{1 . . . M}. In the example embodiment shown in FIG. 5A, N=4 and the four sets of inverters are labeled INV_{1 . . . 4}. In the example embodiment shown in FIG. 5A, the sets of inverters INV₁, INV₂, INV₃, and INV₄, include M−1 inverters labeled I9_{1 . . . (M-1)}, I10_{1 . . . (M-1)}, I11_{1 . . . (M-1)}, and I12_{1 . . . (M-1)}, respectively.

As shown in FIG. 5A, the inverter I0 directly receives an external clock signal ECLK and outputs an inverted external clock signal to the first loop circuit LC₁.

The first loop circuit LC₁ generates N intermediate internal clock signals, each at a corresponding node, wherein a frequency of the N intermediate internal clock signals is a multiple of a frequency of the external clock signal and the inverted external clock signal. In the example embodiment shown in FIG. 5A, the N (=4) nodes are labeled A₁, B₁, C₁, and D₁. As shown in FIG. 5A, the N intermediate internal clock signals are output from nodes A₁, B₁, C₁, and D₁ and input to inverters I9₁, I10₁, I11₁, and I12₁, respectively.

As shown in FIG. 5A, the second loop circuit LC₂ receives the outputs of inverters I9₁, I10₁, I11₁, and I12₁, at nodes A₂, B₂, C₂, and D₂, respectively. N intermediate internal clock signals are output from nodes A₂, B₂, C₂, and D₂and input to inverters I9₂, I10₂, I11₂, and I12₂, respectively.

The Mth loop circuit LC_{M} receives the outputs of inverters I9_{(M-1)}, I10_{(M-1)}, I11_{(M-1)}, and I12_{(M-1)}, at nodes A_{M}, B_{M}, C_{M}, and D_{M}, respectively, and outputs clock signals CLK1, CLK2, CLK3, and CLK4, respectively.

As set forth above, each loop circuit LC_{M} has N nodes, for example, four nodes A, B, C, and D, each of which generates an intermediate internal clock signal.

As shown in FIG. 5A, loop circuits LC_{2-M} are essentially similar to loop circuit LC₁, with the exception that loop circuits LC_{2-M} do not receive an inverted external clock signal.

As shown in FIG. 5A, each loop circuit LC_{M} may include inverters I1-I8. The inverters I1-I8 of each of the loop circuits LC_{M} are arranged to form a first loop composed of inverters I1_{M}-I4_{M}, a second loop composed of inverters I1_{M}, I2_{M}, and I7_{M}, a third loop composed of inverters I3_{M}, I4_{M}, and I8_{M}, a fourth loop composed of inverters I2_{M}, I3_{M}, and I6_{M}, a fifth loop composed of inverters I7_{M} and I8_{M}, a sixth loop composed of inverters I5_{M} and I6_{M}, and a seventh loop composed of inverters I1_{M}, I5_{M}, and I4_{M}.

As set forth above, a plurality of inverters I9_{1 . . . (M-1)}, I10_{1 . . . (M-1)}, I11_{1 . . . (M-1)}, and I12_{1 . . . (M-1)}, for each of nodes A_{M}, B_{M}, C_{M}, and D_{M}, respectively, of each of the loop circuits LC_{M} are connected in series with one another and generate a plurality of clock signals CLK1, CLK2, CLK3, CLK4, as shown in FIG. 5A.

When the external clock signal ECLK is input to the clock generation circuit, the frequency of internal clock signal CLK1, CLK2, CLK3, and CLK4 follow that of the external clock signal ECLK. Further, each of the internal clock signals is output with a 90° phase difference between adjacent clock signals, that is, CLK1 may be set to CLK0, CLK2 may be set CLK90, CLK3 may be set to CLK180, and CLK4 may be set to CLK270.

FIG. 5B is an example equivalent diagram of the clock generation circuit of FIG. 5A.

As shown in FIG. 5B, node A₁ receives the inverted external clock signal as an input, as well as inputs from inverters I4₁ and I7₁. Node A₁ supplies an output to inverters I1₁ and I9₁. As a result, node A₁ receives three inputs and outputs two outputs.

Similarly, node B₁ receives inputs from of inverters I3₁ and I5₁ and supplies outputs to inverters I4₁ and I10₁. As a result, node B₁ receives two inputs and outputs two outputs.

Node C₁ receives inputs from inverters I2₁ and I8₁ and supplies outputs to inverters I3₁ and I11₁. As a result, node C₁ also receives two inputs and outputs two outputs. Node D₁ receives inputs from inverters I1₁ and I6₁ and supplies outputs to inverters I2₁ and I12₁. As a result, node D₁ also receives two inputs and outputs two outputs.

Node A₂ receives inputs from inverters I4_{2,} I7_{2,} and I9₁. Node A₂ supplies an output to inverters I1₂ and I9₂. As a result, node A₂ receives three inputs and outputs two outputs. Node B₂ receives inputs from inverters I3_{2,} I5_{2,} and I10₁. Node B₂ supplies an output to inverters I4₂ and I10₂. As a result, node B₂ receives three inputs and outputs two outputs.

Node C₂ receives inputs from inverters I2_{2,} I8_{2,} and I11₁. Node C₂ supplies an output to inverters I3₂ and I11₂. As a result, node C₂ receives three inputs and outputs two outputs. Node D₂ receives inputs from inverters I1_{2,} I6_{2,} and I12₁. Node D₂ supplies an output to inverters I2₂ and I12₂. As a result, node D₂ receives three inputs and outputs two outputs.

Nodes A₃, B₃, C₃, D₃ to nodes A_{M-1,} B_{M-1,} C_{M-1,} D_{M-1} operate the same as nodes A₂, B₂, C₂, D₂ described above. Nodes A_{M,} B_{M,} C_{M,} D_{M} receive similar inputs to nodes A_{M-1,} B_{M-1,} C_{M-1,} D_{M-1} described above and output internal clock signal CLK1, CLK2, CLK3, and CLK4, respectively.

As shown in FIGS. 5A and 5B, phase interpolation is performed at each of the nodes A₁, B₁, C₁, D₁ to nodes A_{M}, B_{M}, C_{M}, D_{M}. For example, at node A₁ of loop filter LC₁ the inverted external clock signal from inverter I0 is combined with two output signals from inverters I4₁ and I7₁ and interpolated to generate the two output signals supplied to inverters I1₁ and I9₁. Similarly, at node A₂ of loop filter LC₂ the output from inverter I9₁ is combined with two output signals from inverters I4₂ and I7₂ and interpolated to generate the two output signals supplied to inverters I1₂ and I9₂. All other nodes A_{3 . . . M} operate in a similar manner.

At node B₁ of loop filter LC₁ the output signals from inverters I3₁ and I5₁ are combined and interpolated to generate the two output signals supplied to inverters I4₁ and I10₁. Similarly, at node B₂ of loop filter LC₂ the output from inverter I10₁ is combined with two output signals from inverters I3₂ and I5₂ and interpolated to generate the two output signals supplied to inverters I4₂ and I10₂. All other nodes B_{3 . . . M} operate in a similar manner.

At node C₁ of loop filter LC₁ the output signals from inverters I2₁ and I8₁ are combined and interpolated to generate the two output signals supplied to inverters I3₁ and I11₁. Similarly, at node C₂ of loop filter LC₂ the output from inverter I11₁ is combined with two output signals from inverters I2₂ and I8₂ and interpolated to generate the two output signals supplied to inverters I3₂ and I11₂. All other nodes C_{3 . . . M} operate in a similar manner.

At node D₁ of loop filter LC₁ the output signals from inverters I1₁ and I6₁ are combined and interpolated to generate the two output signals supplied to inverters I2₁ and I12₁. Similarly, at node D₂ of loop filter LC₂ the output from inverter I12₁ is combined with two output signals from inverters I1₂ and I6₂ and interpolated to generate the two output signals supplied to inverters I2₂ and I12₂. All other nodes D_{3 . . . M} operate in a similar manner.

The phase difference between adjacent clock signals produced by the loop filter LC₁ is almost 90°. The phase difference between adjacent clock signals produced by loop filter LC₂ is closer to exactly 90°, as compared with loop filter LC₁. The phase difference between adjacent clock signals produced by loop filter LC₃ is even closer to exactly 90° than loop filter LC₂. As a result, the phase difference of the internal clock signal CLK1, CLK2, CLK3, CLK4 becomes closer to exactly 90° as more loop filters LCₘ are added to the clock generation circuit.

As set forth above, when the external clock signal ECLK is input, phase interpolation as described above is performed at each of the nodes and a locking operation for internal clock signals is completed in a relatively short time, compared with the conventional art. Additionally, a clock generation circuit, such as the one illustrated in FIGS. 5A and 5B is more robust with respect to power noise, compared to conventional clock generation circuits.

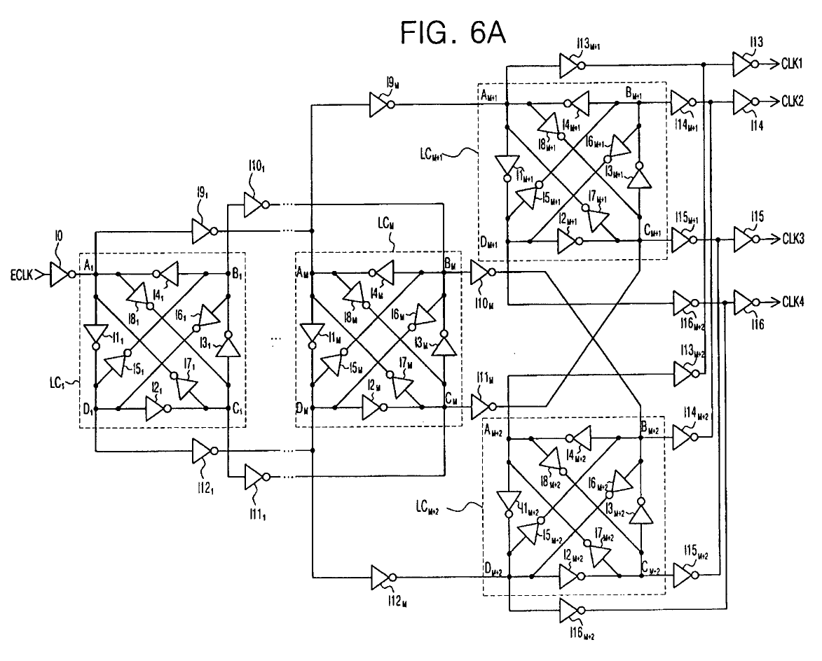

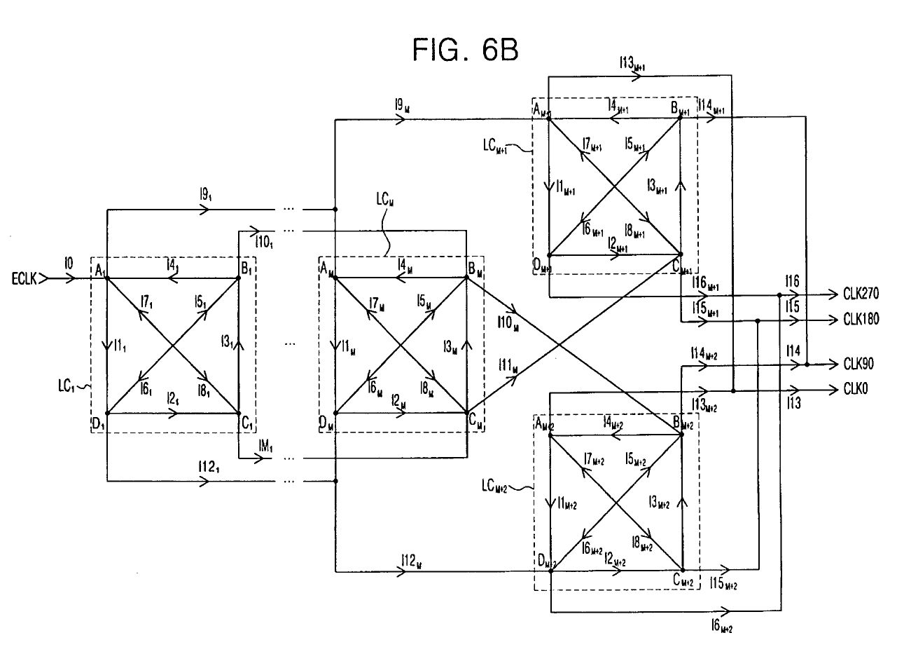

FIG. 6A illustrates a clock generation circuit in accordance with another example embodiment of the present invention, which includes an inverter IO, M (where M is an integer ≧1) loop circuits LC_{1 . . . M+1} arranged in series and N (where N is an integer ≧2) sets of inverters INV_{1 . . . N}.

As shown in FIG. 6A, each of the loop circuits LC_{1 . . . M+1} may include N (where N is an integer ≧2) nodes, where the number of nodes is equal to the number of sets of inverters INV_{1 . . . N}. In the example embodiment shown in FIG. 6A, N=4. The inverter IO, M (where M is an integer ≧1) loop circuits LC_{1 . . . M+1} arranged in series and N (where N is an integer ≧2) sets of inverters INV_{1 . . . N} may be arranged and operate the same as those illustrated in FIGS. 5A and 5B.

The clock generation circuit of FIG. 6A may further include an (M+2)th loop circuit LC_{1 . . . M+2} arranged in parallel with loop circuit LC_{1 . . . M+1}.

The internal arrangement of loop circuit LC_{1 . . . M+1} and LC_{1 . . . M+2} may be the same as loop circuits LC_{1 . . . M}.

As shown in FIG. 6A, some of the nodes of the loop circuit LC_{1 . . . M+1} receive inputs from inverters I9_{M}, I10_{M,} I11_{M} and I12_{M}. For example, as shown in FIG. 6A, nodes A_{M+1} and C_{M+1} receive inputs from inverters I9_{M} and I11_{M}. Further, some of the nodes of the loop circuit LC_{1 . . . M+2} receive inputs from inverters I9_{M}, I10_{M,} I11_{M} and I12_{M}. For example, as shown in FIG. 6A, nodes B_{M+2} and D_{M+2} receive inputs from I10_{M} and I12_{M}.

The clock generation circuit of FIG. 6A further includes a first group of N inverters I13_{M+1}, I14_{M+1}, I15_{M+1}, and I16_{M+1}, each receiving an output from nodes A_{M+1}, B_{M+1}, C_{M+1}, and D_{M+1}, respectively, and a second group of N inverter I13_{M+2}, I14_{M+2}, I15_{M+2}, and I16_{M+2}, each receiving an output from nodes A_{M+2}, B_{M+2}, C_{M+2}, and D_{M+2}, respectively. Outputs of the first group of N inverters I13_{M+1}, I14_{M+1}, I15_{M+1}, and I16_{M+1}, and the second group of N inverters I13_{M+2}, I14_{M+2}, I15_{M+2}, and I16_{M+2}, are input to a third group of inverters I13, I14, I15, and I16, respectively, to produce internal clock signal CLK1, CLK2, CLK3, CLK4, respectively.

FIG. 6B is an example equivalent diagram of the clock generation circuit of FIG. 6A.

As shown in FIGS. 6A and 6B, phase interpolation is performed at each of the nodes A₁, B₁, C₁, D₁ to nodes A_{M+2}, B_{M+2}, C_{M+2}, D_{M+2}. The phase difference between adjacent clock signals produced by the loop filter LC₁ is almost 90°. The phase difference between adjacent clock signals produced by loop filter LC₂ is closer to exactly 90°, as compared with loop filter LC₁. The phase difference between adjacent clock signals produced by loop filter LC₃ is even closer to exactly 90° than loop filter LC₂. As a result, the phase difference of the internal clock signal CLK1, CLK2, CLK3, CLK4 becomes closer to exactly 90° as more loop filters LCₘ are added to the clock generation circuit.

As set forth above, when the external clock signal ECLK is input, phase interpolation as described above is performed at each of the nodes and a locking operation for internal clock signals is completed in a relatively short time compared with the conventional art. Additionally, a clock generation circuit, such as the one illustrated in FIGS. 6A and 6B is more robust with respect to power noise, compared to conventional clock generation circuits.

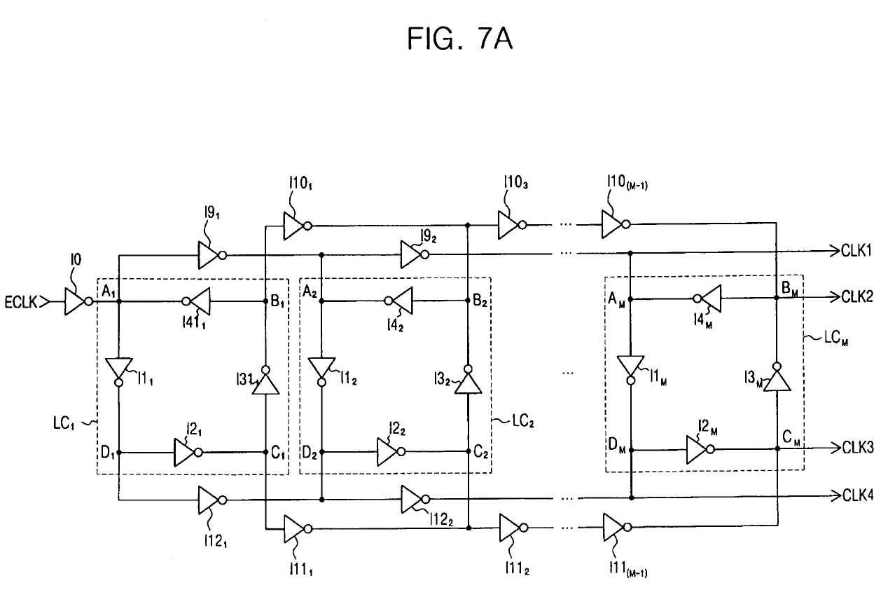

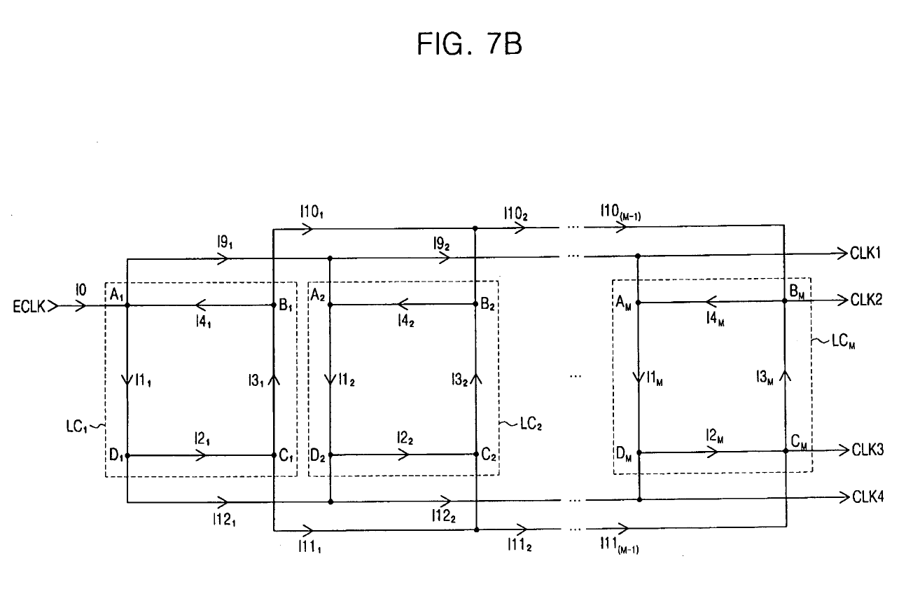

FIG. 7A illustrates a clock generation circuit in accordance with another example embodiment of the present invention, which includes an inverter IO, M (where M is an integer ≧1) loop circuits LC_{1 . . . M} arranged in series and N (where N is an integer ≧2) sets of inverters INV_{1 . . . N}. The example embodiment of FIG. 7A is similar to the example embodiment of FIG. 5A, with the exception that the internal construction of each of loop circuits LC_{1 . . . M} includes N inverters, arranged as a latch circuit. In the example embodiment of FIG. 7A, N=4 and therefore, each loop circuits LC_{1 . . . M} includes four inverters, I1, I2, I3, and I4 and a single loop.

FIG. 7B is an example equivalent diagram of the clock generation circuit of FIG. 7A.

As shown in FIGS. 7A and 7B, phase interpolation is performed at each of the nodes A₁, B₁, C₁, D₁ to nodes A_{M}, B_{M}, C_{M}, D_{M}. The phase difference between adjacent clock signals produced by the loop filter LC₁ is almost 90°. The phase difference between adjacent clock signals produced by loop filter LC₂ is closer to exactly 90°, as compared with loop filter LC₁. The phase difference between adjacent clock signals produced by loop filter LC₃ is even closer to exactly 90° than loop filter LC₂. As a result, the phase difference of the internal clock signal CLK1, CLK2, CLK3, CLK4 becomes closer to exactly 90° as more loop filters LCₘ are added to the clock generation circuit.

As set forth above, when the external clock signal ECLK is input, phase interpolation as described above is performed at each of the nodes and a locking operation for internal clock signals is completed in a relatively short time compared with the conventional art. Additionally, a clock generation circuit, such as the one illustrated in FIGS. 7A and 7B is more robust with respect to power noise, compared to conventional clock generation circuits.

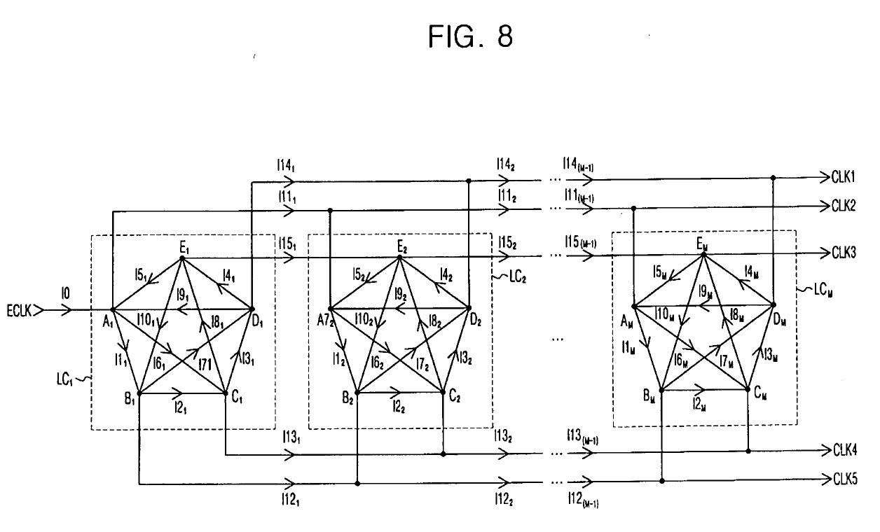

FIG. 8 illustrates an equivalent circuit of a clock generation circuit in accordance with another example embodiment of the present invention, which includes an inverter IO, M (where M is an integer ≧1) loop circuits LC_{1 . . . M} arranged in series and N (where N is an integer ≧2) sets of inverters INV_{1 . . . N}.

As shown in FIG. 8, each of the loop circuits LC_{1 . . . M} may include N (where N is an integer ≧2) nodes, where the number of nodes is equal to the number of sets of inverters INV_{1 . . . N}. In the example embodiment shown in FIG. 8, N=5.

As shown in FIG. 8, each of the N sets of inverters INV_{1 . . . N} includes M−1 inverters, where M is the number of loop circuits LC_{1 . . . M}. In the example embodiment shown in FIG. 8, N=5 and the five sets of inverters are labeled INV_{1 . . . 5}. In the example embodiment shown in FIG. 8, the sets of inverters INV₁, INV₂, INV₃, INV₄, and INV₅ include M−1 inverters labeled I11_{1 . . . (M-1)}, I12_{1 . . . (M-1)}, I13_{1 . . . (M-1)}, I14_{1 . . . (M-1)}, and I15_{1 . . . (M-1)}, respectively.

As shown in FIG. 8, the inverter IO directly receives an external clock signal ECLK and outputs an inverted external clock signal to the first loop circuit LC₁.

As shown in FIG. 8, the first loop circuit LC₁ generates N intermediate internal clock signals, each at a corresponding node, wherein a frequency of the N intermediate internal clock signals is a multiple of a frequency of the external clock signal and the inverted external clock signal. In the example embodiment shown in FIG. 8, the N (=5) nodes are labeled A₁, B₁, C₁, D₁, and E₁. As shown in FIG. 8, the N intermediate internal clock signals are output from nodes A₁, B₁, C₁, D₁, and E₁ and input to inverters I11₁, I12₁, I13₁, I14₁, and I15₁, respectively.

As shown in FIG. 8, the second loop circuit LC₂ receives the outputs of inverters I11₁, I12₁, I13₁, I14₁, and I15₁, at nodes A₁, B₁, C₁, D₁, and E₁, respectively. N intermediate internal clock signals are output from nodes A₁, B₁, C₁, D₁, and E₁ and input to inverters I11₂, I12₂, I13₂, I14₂, and I15₂, respectively.

As shown in FIG. 8, the Mth loop circuit LC_{M} receives the outputs of inverters I11_{(M-1)}, I12_{(M-1)}, I13_{(M-1)}, I14_{(M-1)}, and I15_{(M-1)}, at nodes A_{M}, B_{M}, C_{M}, D_{M}, and Eₘ, respectively, and output clock signals CLK1, CLK2, CLK3, CLK4, and CLK5, respectively.

As set forth above, each loop circuit LC_{M} has N nodes, for example, five nodes A, B, C, D, and E, each of which generates an intermediate internal clock signal.

As shown in FIG. 8, loop circuits LC_{2-M} are essentially similar to loop circuit LC₁, with the exception that loop circuits LC_{2-M} do not receive an inverted external clock signal.

As shown in FIG. 8, each loop circuit LC_{M} may include inverters I1-I10. As described above in conjunction with FIG. 5A, the inverters I1-I10 of each of the loop circuits LC_{M} may be arranged to form a plurality of loops, each composed of a subset of inverters I1-I10.

As set forth above, a plurality of inverters I11_{1 . . . (M-1)}, I12_{1 . . . (M-1)}, I13_{1 . . . (M-1)}, I14_{1 . . . (M-1)}, and I15_{1 . . . (M-1)}, for each of nodes A_{M}, B_{M}, C_{M}, D_{M}, and E_{M}, respectively, of each of the loop circuits LC_{M} are connected in series with one another and generate a plurality of clock signals CLK1, CLK2, CLK3, CLK4, and CLK5, as shown in FIG. 8.

When the external clock signal ECLK is input to the clock generation circuit, the frequency of internal clock signal CLK1, CLK2, CLK3, CLK4, and CLK5 follow that of the external clock signal ECLK. Further, each of the internal clock signals is output with a 72° phase difference between adjacent clock signals, that is, CLK1 may be set to CLK0, CLK2 may be set CLK72, CLK3 may be set to CLK144, CLK4 may be set to CLK216, and CLK5 may be set to CLK288.

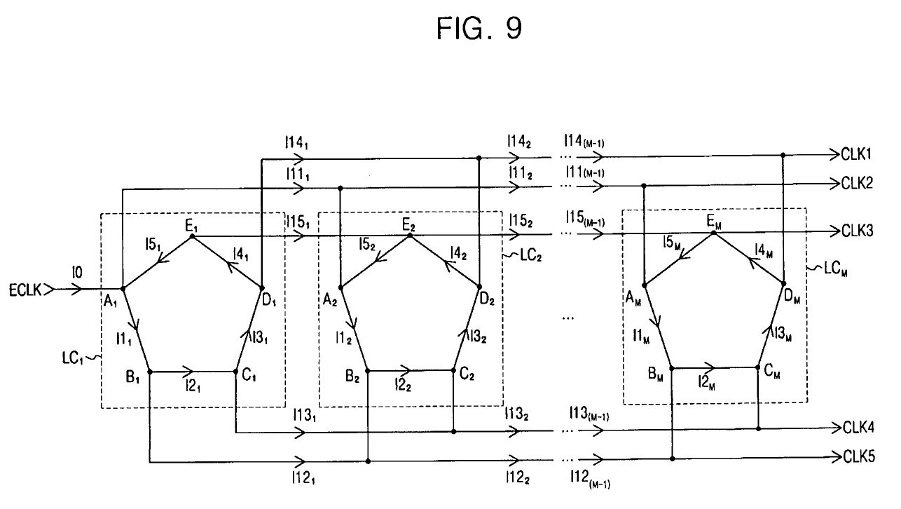

FIG. 9 is an example equivalent diagram of a clock generation circuit, with a single loop or latch configuration, in accordance with another example embodiment of the present invention, where N=5.

As shown in FIGS. 8 and 9, phase interpolation is performed at each of the nodes A₁, B₁, C₁, D₁, E₁ to nodes A_{M}, B_{M}, C_{M}, D_{M}, E_{M}. The phase difference between adjacent clock signals produced by the loop filter LC₁ is almost 72°. The phase difference between adjacent clock signals produced by loop filter LC₂ is closer to exactly 72°, as compared with loop filter LC₁. The phase difference between adjacent clock signals produced by loop filter LC₃ is even closer to exactly 72° than loop filter LC₂. As a result, the phase difference of the internal clock signal CLK1, CLK2, CLK3, CLK4, CLK5 becomes closer to exactly 72° as more loop filters LCₘ are added to the clock generation circuit.

As set forth above, when the external clock signal ECLK is input, phase interpolation as described above is performed at each of the nodes and a locking operation for internal clock signals is completed in a relatively short time compared with the conventional art. Additionally, a clock generation circuit, such as the one illustrated in FIGS. 8 and 9 is more robust with respect to power noise, compared to conventional clock generation circuits.

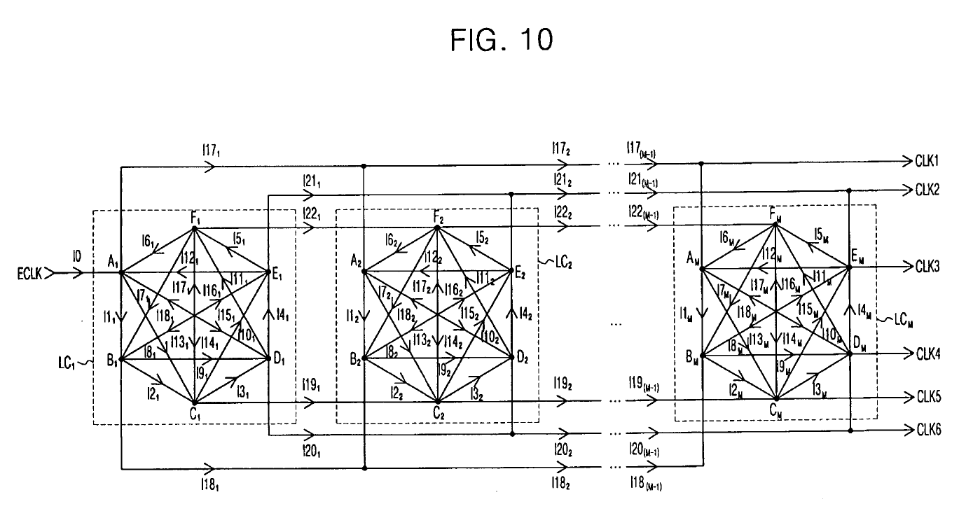

FIG. 10 illustrates an equivalent circuit of a clock generation circuit in accordance with an example embodiment of the present invention, which includes an inverter IO, M (where M is an integer ≧1) loop circuits LC_{1 . . . M} arranged in series and N (where N is an integer ≧2) sets of inverters INV_{1 . . . N}.

As shown in FIG. 10, each of the loop circuits LC_{1 . . . M} may include N (where N is an integer ≧2) nodes, where the number of nodes is equal to the number of sets of inverters INV_{1 . . . N}. In the example embodiment shown in FIG. 10, N=6.

As shown in FIG. 10, each of the N sets of inverters INV_{1 . . . N} includes M−1 inverters, where M is the number of loop circuits LC_{1 . . . M}. In the example embodiment shown in FIG. 10, N=6 and the six sets of inverters are labeled INV_{1 . . . 6}. In the example embodiment shown in FIG. 10, the sets of inverters INV₁, INV₂, INV₃, INV₄, INV₅, and INV₆ include M−1 inverters labeled I17_{1 . . . (M-1)}, I18_{1 . . . (M-1)}, I19_{1 . . . (M-1)}, I20_{1 . . . (M-1)}, I21_{1 . . . (M-1)}, and I22_{1 . . . (M-1)}, respectively.

As shown in FIG. 10, the inverter I0 directly receives an external clock signal ECLK and outputs an inverted external clock signal to the first loop circuit LC₁.

As shown in FIG. 10, the first loop circuit LC₁ generates N intermediate internal clock signals, each at a corresponding node, wherein a frequency of the N intermediate internal clock signals is a multiple of a frequency of the external clock signal and the inverted external clock signal. In the example embodiment shown in FIG. 10, the N (=6) nodes are labeled A₁, B₁, C₁, D₁, E₁, and F₁. As shown in FIG. 10, the N intermediate internal clock signals are output from nodes A₁, B₁, C₁, D₁, E₁, and F₁ and input to inverters I17₁, I18₁, I19₁, I20₁, I21₁, and I22₁, respectively.

As shown in FIG. 10, the second loop circuit LC₂ receives the outputs of inverters I17₁, I18₁, I19₁, I20₁, I21₁, and I22₁, at nodes A₂, B₂, C₂, D₂, E₂, and F₂, respectively. N intermediate internal clock signals are output from nodes A₂, B₂, C₂, D₂, E₂, and F₂ and input to inverters I17₂, I18₂, I19₂, I20₂, I21₂, and I22₂, respectively.

As shown in FIG. 10, the Mth loop circuit LC_{M} receives the outputs of inverters I17_{(M-1)}, I18_{(M-1)}, I19_{(M-1)}, I20_{(M-1)}, I21_{(M-1)}, and I22_{(M-1)}, at nodes A_{M}, B_{M}, C_{M}, D_{M}, E_{M}, and F_{M}, respectively, and output clock signals CLK1, CLK2, CLK3, CLK4, CLK5, and CLK6, respectively.

As set forth above, each loop circuit LC_{M} has N nodes, for example, six nodes A, B, C, D, E, and F, each of which generates an intermediate internal clock signal.

Loop circuits LC_{2-M} are essentially similar to loop circuit LC₁, with the exception that loop circuits LC_{2-M} do not receive an inverted external clock signal.

As shown in FIG. 10, each loop circuit LC_{M} may include inverters I1-I18. As shown in FIG. 10, the inverters I1-I18 of each of the loop circuits LC_{M} are arranged to form a plurality of loops, each composed of a subset of inverters I1-I18.

As set forth above, a plurality of inverters I17_{(M-1)}, I18_{(M-1)}, I19_{(M-1)}, I20_{(M-1)}, I21_{(M-1)}, and I22_{(M-1)}, for each of nodes A_{M}, B_{M}, C_{M}, D_{M}, E_{M}, and F_{M}, respectively, of each of the loop circuits LC_{M} are connected in series with one another and generate a plurality of clock signals CLK1, CLK2, CLK3, CLK4, CLK5, and CLK6, as shown in FIG. 10.

When the external clock signal ECLK is input to the clock generation circuit, the frequency of internal clock signal CLK1, CLK2, CLK3, CLK4, CLK5, and CLK6 follow that of the external clock signal ECLK. Further, each of the internal clock signals is output with a 60° phase difference between adjacent clock signals, that is, CLK1 may be set to CLK0, CLK2 may be set CLK60, CLK3 may be set to CLK120, CLK4 may be set to CLK180, CLK5 may be set to CLK240, and CLK6 may be set to CLK300.

As shown in FIG. 10, phase interpolation is performed at each of the nodes A₁, B₁, C₁, D₁, E₁, and F₁ to nodes A_{M}, B_{M}, C_{M}, D_{M}, E_{M}, and F_{M}.

The phase difference between adjacent clock signals produced by the loop filter LC₁ is almost 60°. The phase difference between adjacent clock signals produced by loop filter LC₂ is closer to exactly 60°, as compared with loop filter LC₁. The phase difference between adjacent clock signals produced by loop filter LC₃ is even closer to exactly 60° than loop filter LC₂. As a result, the phase difference of the internal clock signal CLK1, CLK2, CLK3, CLK4, CLK5, and CLK6 becomes closer to exactly 60° as more loop filters LCₘ are added to the clock generation circuit.

As set forth above, when the external clock signal ECLK is input, phase interpolation as described above is performed at each of the nodes and a locking operation for internal clock signals is completed in a relatively short time compared with the conventional art. Additionally, a clock generation circuit, such as the one illustrated in FIGS. 10 is more robust with respect to power noise, compared to conventional clock generation circuits.

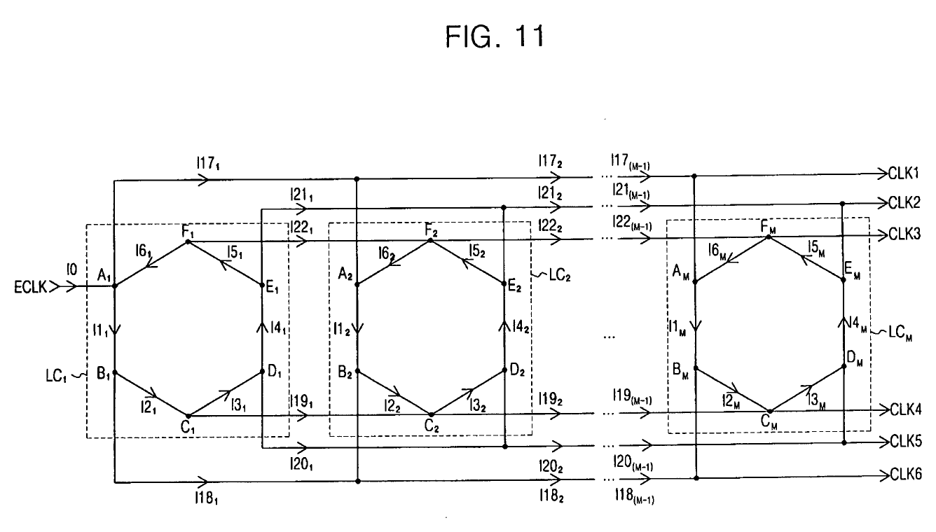

FIG. 11 illustrates an equivalent circuit of a clock generation circuit in accordance with another example embodiment of the present invention, which includes an inverter IO, M (where M is an integer ≧1) loop circuits LC_{1 . . . M} arranged in series and N (where N is an integer ≧2) sets of inverters INV_{1 . . . N}. The example embodiment of FIG. 11 is similar to the example embodiment of FIG. 10, with the exception that the internal construction of each of loop circuits LC_{1 . . . M} includes N inverters, is arranged as a latch circuit. In the example embodiment of FIG. 11, N=6 and therefore, each loop circuits LC_{1 . . . M} includes six inverters, I1, I2, I3, I4, I5, and I6 and a single loop.

As shown in FIG. 11, phase interpolation is performed at each of the nodes A₁, B₁, C₁, D₁ E₁, and F₁ to nodes A_{M}, B_{M}, C_{M}, D_{M}, E_{M}, and F_{M}. The phase difference between adjacent clock signals produced by the loop filter LC₁ is almost 60°. The phase difference between adjacent clock signals produced by loop filter LC₂ is closer to exactly 60°, as compared with loop filter LC₁. The phase difference between adjacent clock signals produced by loop filter LC₃ is even closer to exactly 60° than loop filter LC₂. As a result, the phase difference of the internal clock signal CLK1, CLK2, CLK3, CLK4, CLK5, CLK6 becomes closer to exactly 60° as more loop filters LCₘ are added to the clock generation circuit.

As set forth above, when the external clock signal ECLK is input, phase interpolation as described above is performed at each of the nodes and a locking operation for internal clock signals is completed in a relatively short time compared with the conventional art. Additionally, a clock generation circuit, such as the one illustrated in FIG. 11 is more robust with respect to power noise, compared to conventional clock generation circuits.

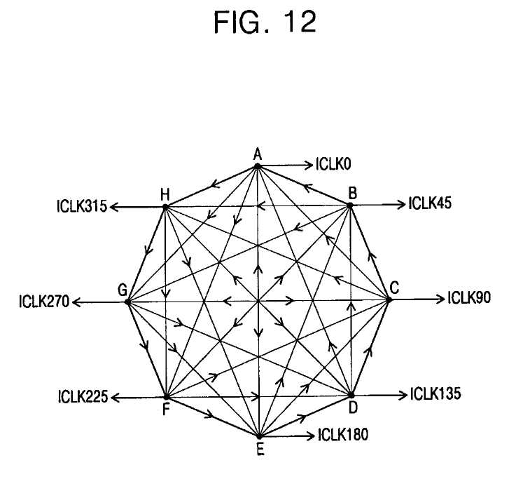

FIG. 12 is an example equivalent diagram of a loop circuit in accordance with another example embodiment of the present invention, illustrating a plurality of inverters, eight (8) nodes A-H, and clock signals ICLK0, ICLK45, ICLK90, ICLK135 ICLK180, ICLK225, ICLK270, and ICLK315. In an example embodiment, the phases of nodes A-H may differ by 45°. In the example embodiment of FIG. 12, each of nodes A-H may receive four inputs and output three outputs.

As described above, a clock generation circuit in accordance with example embodiments of the present invention may have a serial configuration, for example, as illustrated in FIGS. 5A, 5B, 7A, 7B, and 8-11 or a serial-parallel configuration for example, as illustrated in FIGS. 5A and 5B.

As described above, a loop circuit in accordance with example embodiments of the present invention may have a multiple loop configuration for example, as illustrated in FIGS. 5A, 5B, 6A, 6B, 8, 10, and 12 or a single loop or latch configuration for example, as illustrated in FIGS. 7A, 7B, 9, and 11. Further, a loop circuit in accordance with example embodiments of the present invention may have N nodes, where N is an integer ≧2, for example, 4, 5, 6, 8, 9, 10, 12, 15, or 18. Additionally, a clock generation circuit in accordance with example embodiments of the present invention may have any combination of clock generation circuit configurations, loop circuit configurations, and number of nodes N.

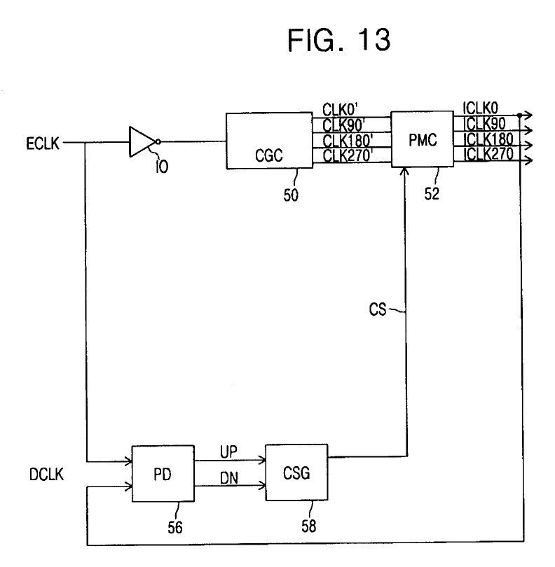

FIG. 13 illustrates a multiphase clock generator in accordance with an example embodiment of the present invention, which may include any of the clock generation circuits described above in conjunction with FIGS. 5A-12.

As shown, the multiphase clock generator of FIG. 13 may include a clock generation circuit (CGC) 50, a phase modifying circuit (PMC) 52, a phase detector (PD) 56, and/or a control signal generator (CSG) 58. The clock generation circuit (CGC) 50 receives an external clock, for example, ECLK, described above and generates N first internal clock signals, for example, CLK1, CLK2, CLK3, CLK4 of FIGS. 5A-7B as N first internal clock signals CLK0′, CLK90′, CLK180′, CLK270′. CLK0′, CLK90′, CLK180′, CLK270′ have the same frequency as ECLK.

The phase modifying circuit (PMC) 52 receives the N first internal clock signals CLK0′, CLK90′, CLK180′, CLK270′ and at least one control signal CS from the control signal generator (CSG) 58 as inputs, and generates N second clock signals ICLK0, ICLK90, ICLK180, ICLK270. Any one of the N second clock signals ICLK0, ICLK90, ICLK180, ICLK270 may be used a feedback signal, output to the phase detector (PD) 56, as discussed below.

The phase detector (PD) 56 receives the external clock signal ECLK and one of the N second clock signals ICLK0, ICLK90, ICLK180, ICLK270 as a feedback signal DCLK and outputs an UP signal when a phase of ECLK leads a phase of the feedback clock signal DCLK and outputs a DOWN signal when the phase of ECLK lags the phase of the feedback clock signal DCLK.

The control signal generator (CSG) 58 receives the UP signal and the DOWN signal from the phase detector (PD) 56 and outputs the at least one control signal CS to the phase modifying circuit (PMC) 52.

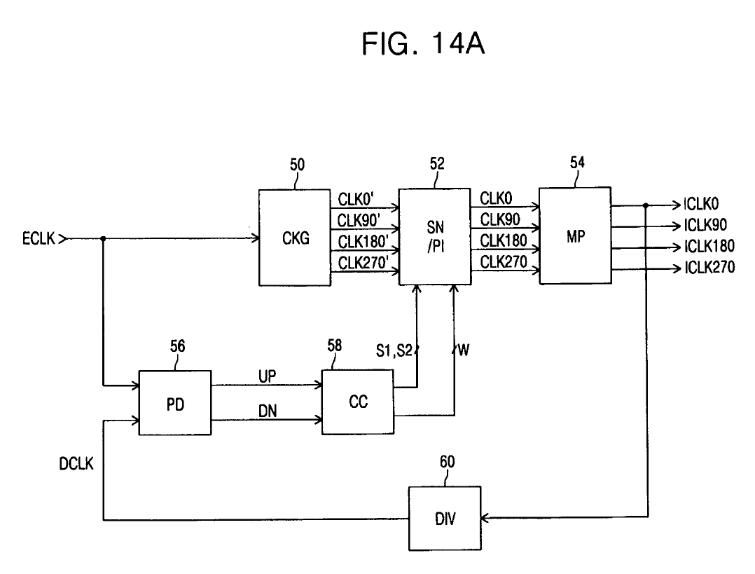

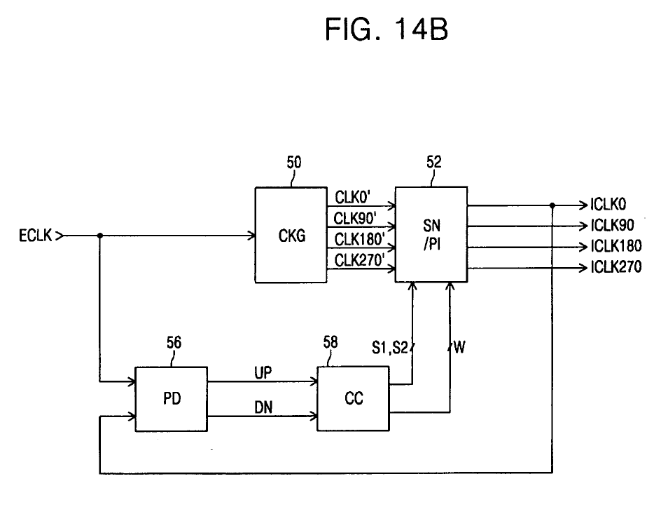

FIG. 14A illustrates a multiphase clock generator in accordance with another example embodiment of the present invention, which also may include any of the clock generation circuits described above in conjunction with FIGS. 5A-12.

As shown, the multiphase clock generator of FIG. 14A further includes a multiplier (MP) 54 and a divider (DIV) 60, the phase modifying circuit (PMC) 52 includes a selection and phase interpolation circuit (SN/PI) 521, and the control signal generator (CSG) 58 includes a control circuit (CC) 581. In the example embodiment shown in FIG. 14A, the at least one control signal includes selection signals S1, S2 and a weight signal W.

The N first internal clock signals CLK0′, CLK90′, CLK180′, CLK270′ have identical phase differences (90°) between adjacent clock signals. The selection and phase interpolation circuit (SN/PI) 521 selects two clock signals among the N first internal clock signals CLK0′, CLK90′, CLK180′, CLK270′ in response to the selection signals S1, S2 and interpolates the phases of the selected two clock signals in response to the weight signal W to generate N second internal clock signals CLK0, CLK90, CLK180, CLK270 synchronized with ECLK.

The multiplier (MP) 54 multiplies a frequency of the second internal clock signals CLK0, CLK90, CLK180, CLK270 to generate the N second clock signals ICLK0, ICLK90, ICLK180, ICLK270 having a higher frequency than that of the second internal clock signals CLK0, CLK90, CLK180, CLK270. For example, ECLK, the N first internal clock signals CLK0′, CLK90′, CLK180′, CLK270′, and the second internal clock signals CLK0, CLK90, CLK180, CLK270 may have a frequency of 1 GHz, whereas, the N second clock signals ICLK0, ICLK90, ICLK180, ICLK270 may have a frequency of X GHz (where X is an integer>1).

The control circuit (CC) 581 generates the selection signals S1, S2 and the weight signal W in response to the UP or DOWN signals from the phase detector (PD) 56. The divider (DIV) 60 divides a frequency of the one of the N second clock signals ICLK0, ICLK90, ICLK180, ICLK270 selected as the feedback signal from X GHz (where X is an integer>1) back down to the frequency of ECLK. The output of the divider (DIV) 60 is input to the phase detector (PD) 56 as the feedback clock DCLK.

FIG. 14B illustrates a multiphase clock generator in accordance with another example embodiment of the present invention, which also may include any of the clock generation circuits described above in conjunction with FIGS. 5A-12.

As shown, the multiphase clock generator of FIG. 14B does not require the multiplier (MP) 54 or divider (DIV) 60. Therefore, the N second clock signals ICLK0, ICLK90, ICLK180, ICLK270 have the same frequency as ECLK.

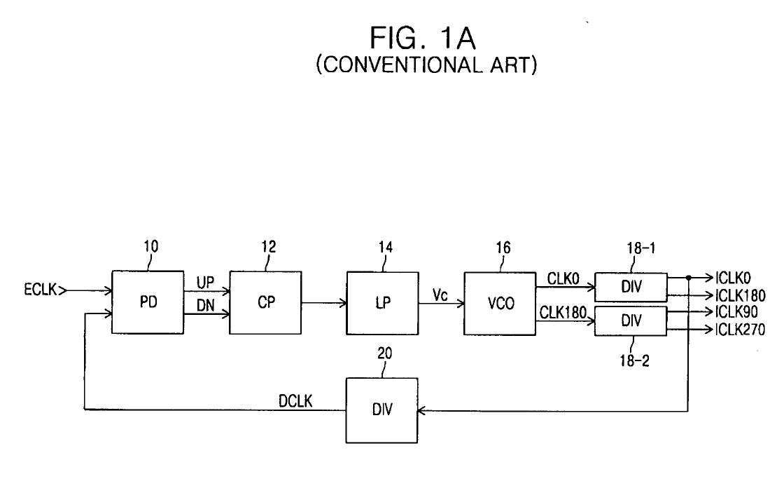

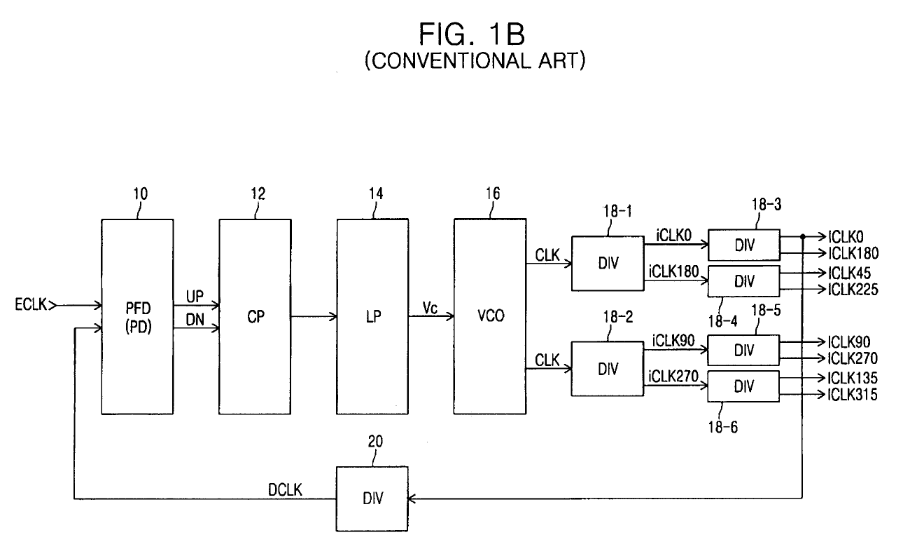

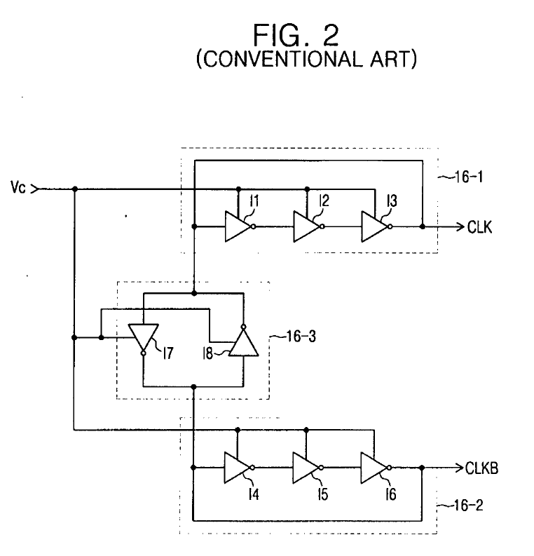

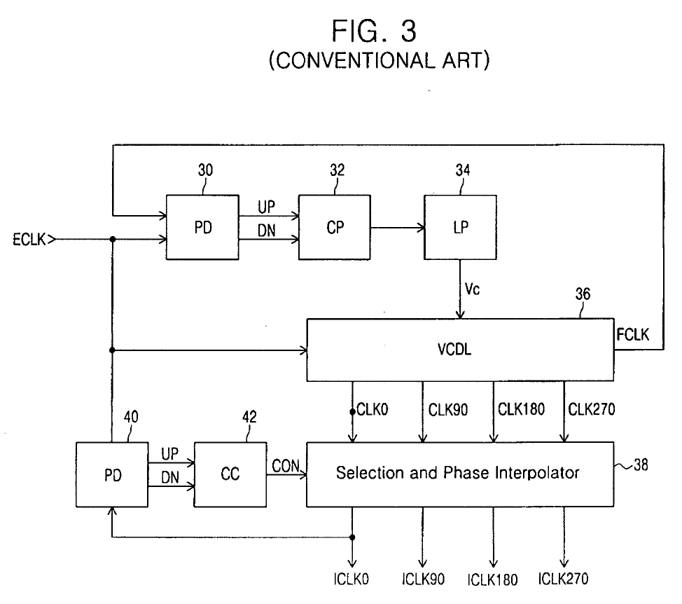

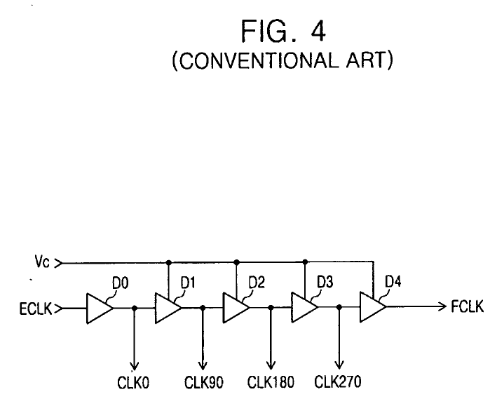

As shown in FIGS. 14A and 14B, a multiphase clock generator according to example embodiments of the present invention may comprise a clock generation circuit, instead of a loop configuration circuit, which may be composed of a phase detector, a charge pump, a loop filter and/or a voltage controlled delay line, such as, for example, those illustrated in FIGS. 1A and 1B. Therefore, when an external clock signal ECLK is input, a plurality of clock signals CLK0′, CLK90′, CLK180′, CLK270′ may be generated with higher speed than the conventional art and may have the same frequency as ECLK together with a desired phase difference (for example, 90°) between adjacent clock signals. As a result, locking time may be reduced in a multiphase clock generator according to example embodiments of the present invention.

Further, an external clock signal ECLK is directly input to a clock generation circuit according to example embodiments of the present invention so that the plurality of clock signals CLK0′, CLK90′, CLK180′, CLK270′ are less affected, as compared to the conventional art, by variations in a power supply voltage, caused by noise. Thus, a clock generation circuit according to example embodiments of the present invention may output more accurate clock signals with less error or without errors.

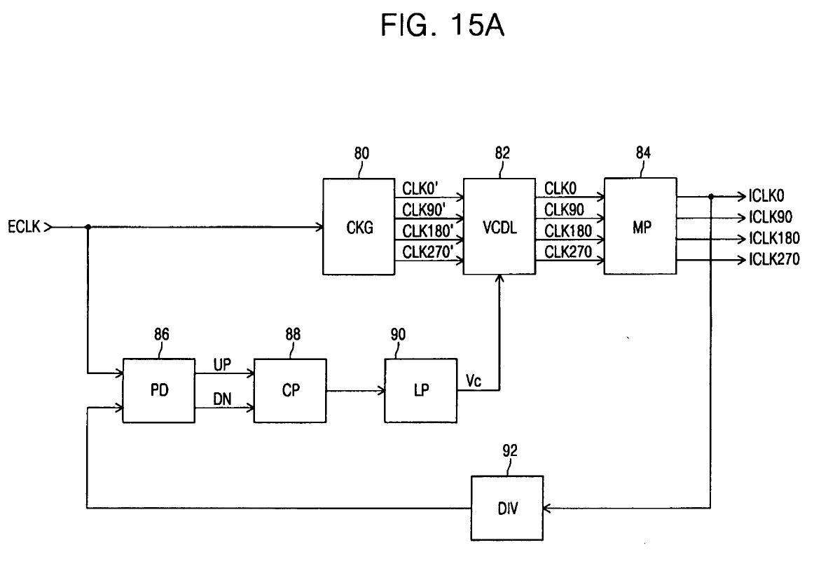

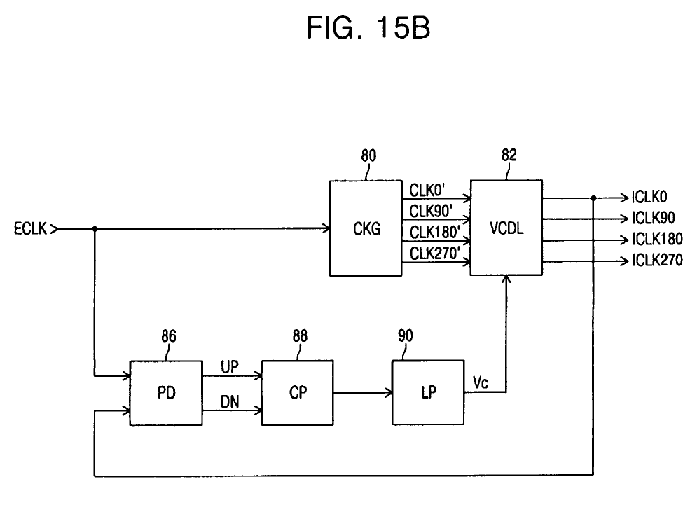

FIG. 15A illustrates a multiphase clock generator in accordance with another example embodiment of the present invention, which also may include any of the clock generation circuits described above in conjunction with FIGS. 5A-12.

As shown, the multiphase clock generator of FIG. 15A further includes a multiplier (MP) 84 and a divider (DIV) 92, the phase modifying circuit (PMC) 52 includes a voltage controlled delay line (VCDL) 82, instead of the selection and phase interpolation 52 of FIGS. 14A and 14B, and the control signal generator (CSG) 58 includes a charge pump 88 and a loop filter 90 instead of the control circuit (CC) 581 of FIGS. 14A and 14B. In the example embodiment shown in FIG. 15A, the at least one control signal includes the control voltage Vc.

The N first internal clock signals CLK0′, CLK90′, CLK180′, CLK270′ have identical phase differences (90°) between adjacent clock signals. The voltage controlled delay line (VCDL) 82 adjusts a delay time of first internal clock signals (CLK0′-CLK270′) to generate second internal clock signals (CLK0-CLK270) in synchronization with the external clock signal ECLK in response to the control voltage Vc.

The multiplier (MP) 54 multiplies a frequency of the second internal clock signals CLK0, CLK90, CLK180, CLK270 to generates the N second clock signals ICLK0, ICLK90, ICLK180, ICLK270 having a higher frequency than that of the second internal clock signals CLK0, CLK90, CLK180, CLK270. For example, ECLK, the N first internal clock signals CLK0′, CLK90′, CLK180′, CLK270′, and the second internal clock signals CLK0, CLK90, CLK180, CLK270 may have a frequency of 1 GHz, whereas, the N second clock signals ICLK0, ICLK90, ICLK180, ICLK270 may have a frequency of X GHz (where X is an integer>1).

The control signal generator (CSG) 58, including the charge pump 88 and the loop filter 90 generate the control voltage Vc in response to the UP or DOWN signals from the phase detector (PD) 86. The divider (DIV) 92 divides a frequency of the one of the N second clock signals ICLK0, ICLK90, ICLK180, ICLK270 selected as the feedback signal from X GHz (where X is an integer>1) back down to the frequency of ECLK. The output of the divider (DIV) 92 is input to the phase detector (PD) 86 as the feedback clock DCLK.

FIG. 15B illustrates a multiphase clock generator in accordance with another example embodiment of the present invention, which also may include any of the clock generation circuits described above in conjunction with FIGS. 5A-12.

As shown, the multiphase clock generator of FIG. 15B does not require the multiplier (MP) 84 or divider (DIV) 92. Therefore, the N second clock signals ICLK0, ICLK90, ICLK180, ICLK270 have the same frequency as ECLK.

As shown in FIGS. 15A and 15B, a multiphase clock generator according to example embodiments of the present invention may comprise a clock generation circuit, instead of a loop configuration circuit, which may be composed of a phase detector, a charge pump, a loop filter and/or a voltage controlled delay line, such as, for example, those illustrated in FIGS. 1A and 1B. Therefore, when an external clock signal ECLK is input, a plurality of clock signals CLK0′, CLK90′, CLK180′, CLK270′ may be generated with higher speed than the conventional art and may have the same frequency as ECLK together with a desired phase difference (for example, 90°) between adjacent clock signals. As a result, locking time may be reduced in a multiphase clock generator according to example embodiments of the present invention.

Further, an external clock signal ECLK is directly input to a clock generation circuit according to example embodiments of the present invention so that the plurality of clock signals CLK0′, CLK90′, CLK180′, CLK270′ are less affected, as compared to the conventional art, by variations in a power supply voltage, caused by noise. Thus, a clock generation circuit according to example embodiments of the present invention may output more accurate clock signals with less error or without errors.

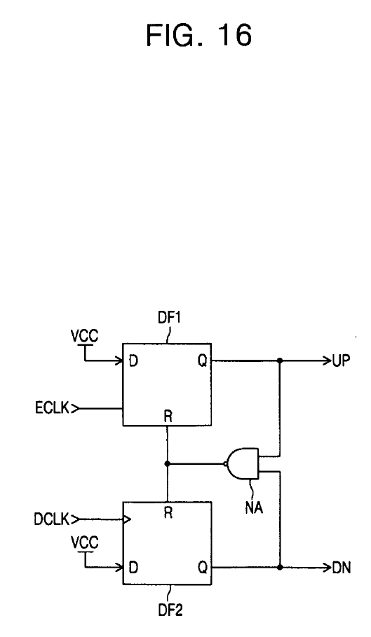

FIG. 16 illustrates a phase detector in accordance with another example embodiment of the present invention, for example, phase detector 56, 86, described above in conjunction with FIGS. 13-15B.

The phase detector 56, 86 may include two or more flip-flops DF1, DF2 and a NAND gate NA. A voltage VCC is supplied to as an input of both flip-flops DF1, DF2. The external clock ECLK is supplied as the clock for flip-flop DF1 and the feedback clock DCLK, for example, from the phase modifying circuit 52 of FIG. 13, the selection and phase interpolation circuit 521 of FIG. 14A, the divider 60 of FIG. 14B, the voltage controlled delay line (VCDL) 82 of FIG. 15A, the divider 92 of FIG. 15B, is supplied as the clock for flip-flop DF2. The stored data output Q of flip-flop DF1 is output as the UP signal and the stored data output Q of flip-flop DF2 is output as the DOWN signal.

The stored data output Q of flip-flop DF1 and the stored data output Q of flip-flop DF2 are input to the NAND gate NA and the NANDed result is returned to flip-flop DF1 and flip-flop DF2.

The phase detector 56, 86 measures a phase difference between the external clock ECLK and the feedback clock DCLK and generates the UP or DN control signals, for example, to control circuit (CC) 581, in order to generate the selection signals S1, S2 and the weight signal W or to charge pump 88, in order to charge and discharge the loop filter 90. The control circuit (CC) 581 may set the selection signals S1, S2 and the weight signal W and the charge pump 88 may set the control voltage (Vc), in response to UP or DN control signals.

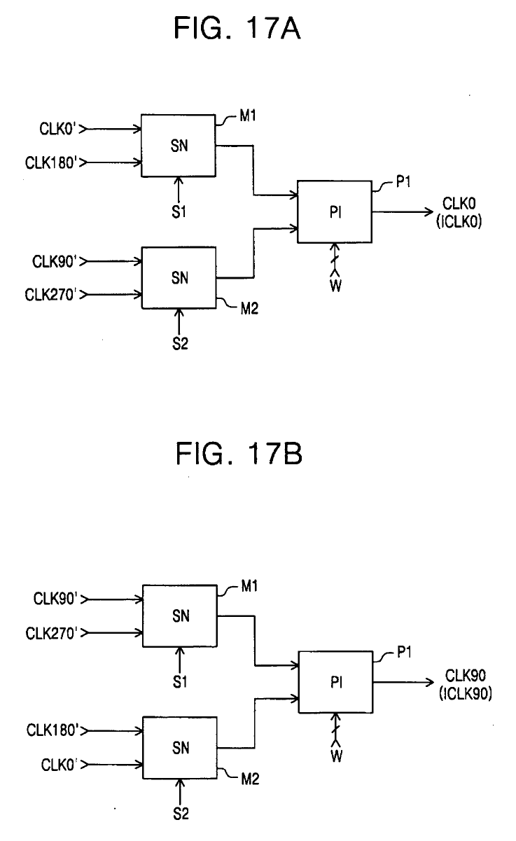

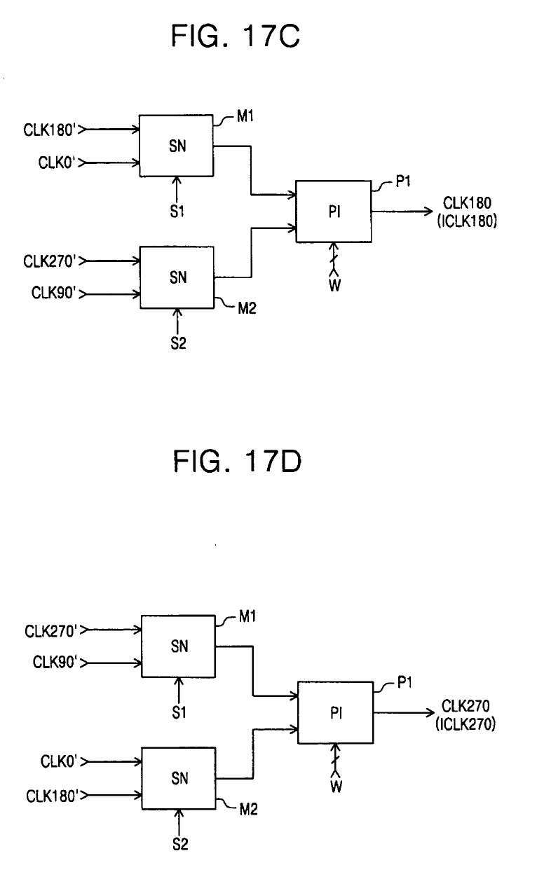

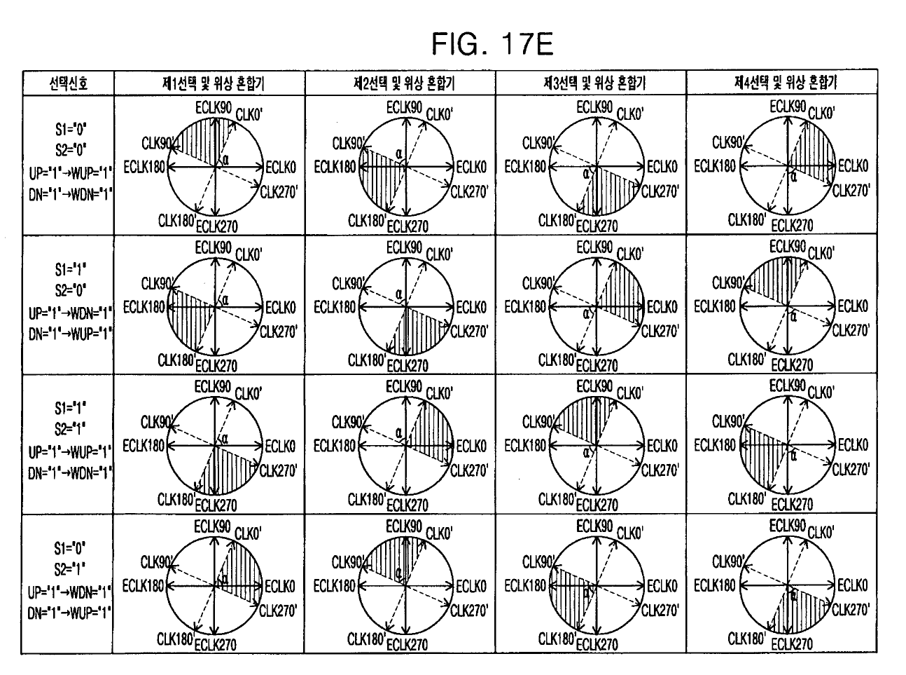

FIG. 17A-17D illustrate a selection and phase interpolation circuit in accordance with another example embodiment of the present invention, for example, selection and phase interpolation circuit 521, described above in conjunction with FIGS. 14A-14B.

When a first control signal S1, supplied for example, by the control circuit (CC) 581 of FIGS. 14A-14B, is at a low level, a first selection circuit M1 outputs first and second first internal clock signals CLK0′ and CLK90′. When the first control signal S1 is at a high level, the first selection circuit M1 outputs third and fourth first internal clock signals CLK180′ and CLK270′.

When a second control signal S2 is at a low level, a second selection circuit M2 outputs second and third first internal clock signals CLK90′ and CLK180′. When the second control signal S2 is at a high level, the second selection circuit M2 outputs fourth and first internal clock signals CLK270′ and CLK0′. As described above, the first selection circuit M1 and the second selection circuit M2 perform coarse phase selection.

The phase interpolator (PI) outputs second internal clock signals CLK0 and CLK90 or second clock signals ICLK0 and ICLK90 after interpolating two first internal clock signals from the selection circuits M1 and M2, in response to the weight signal W.

When the first control signal S1 is at a low level, the first selection circuit M1 outputs third and fourth first internal clock signals CLK180′ and CLK270′ and when the first control signal S1 is at a high level, the first selection circuit M1 outputs first and second first internal clock signals CLK0′ and CLK90′.

When the second control signal S2 is at a low level, the second selection circuit M2 outputs fourth and first internal clock signals CLK270′ and CLK0′ and when the second control signal S2 is at a high level, the second selection circuit M2 outputs second and third first internal clock signals CLK90′ and CLK180′. Each of phase interpolation PI outputs second internal clock signals CLK180 and CLK270 or second clock signals ICLK180 and ICLK270 after interpolated with selected two clock signals from selection circuits M1 and M2 in response to the weight signal W. As described above, the phase interpolator (PI) performs fine phase interpolation.

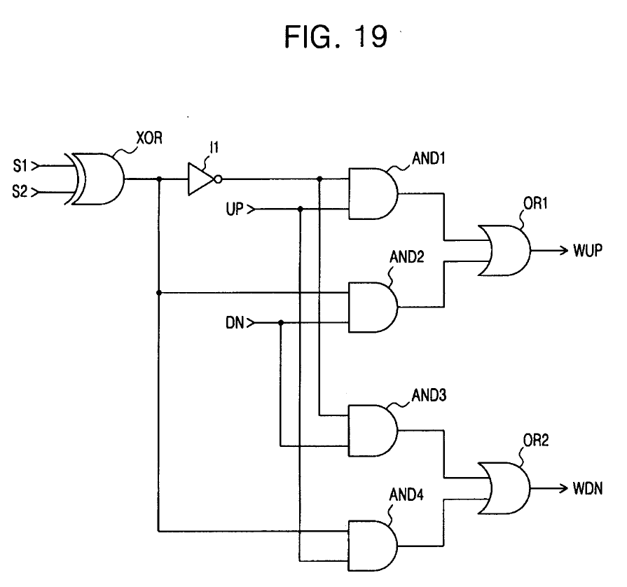

The operation of the selection and phase interpolation circuit 521 is described in more detail below in conjunction with the description of the of the weight control generator 72 of FIG. 19.

FIG. 17E illustrates the relationship between various phases of ECLK, CLK0′, CLK90′, CLK180′, and CLK270′ for all combinations of values supplied by the control signal generator 58 of FIG. 13.

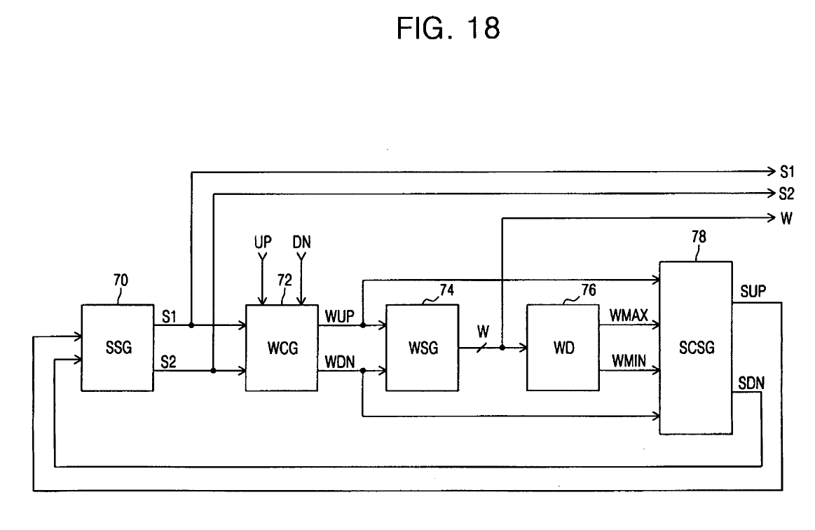

FIG. 18 illustrates a control circuit in accordance with another example embodiment of the present invention, for example, control circuit (CC) 581, described above in conjunction with FIGS. 14A-14B.

A selection signal generator (SSG) 70 performs an UP counting operation in response to a first selection control signal SUP and performs a down counting operation in response to second selection control signal SDN.

For example, assuming that the initial value of S1, S2 is “00”, the value of S1, S2 may be changed with an order of “10”→“11”→“01” in response to the activated SUP signal. When the SDN signal is activated, the value of S1, S2 may be changed with an order of “01”→“11”→“10”. The control signals S1, S2 may be supplied to the selection and phase interpolation circuit (SN/PI) 521 of FIGS. 14A-14B.

A weight control generator (WCG) 72 generates a first weight control signal WUP in response to the UP signal from phase detector (PD) 56, 86 and generates a second weight control signal WDN in response to the DN signal from phase detector (PD) 56, 86, when the value of S1, S2 becomes “00” or “11”, respectively.

Further, the weight control generator (WCG) 72 generates the second weight control signal WDN in response to the UP signal from phase detector (PD) 56, 86 and generates the first weight control signal WUP in response to DN signal from phase detector (PD) 56, 86, when the value of S1, S2 becomes “01” or “10”, respectively. A weight signal generator (WSG) 74 performs up counting operation in response to a WUP signal and performs down counting operation in response to a WDN signal, and outputs the weight signal W. The weight signal W may be composed of a plurality of bits.

A weight minimum/maximum detector (WD) 76 generates a first weight detecting signal (WMAX) when the all the bits of the weight signal W are high, for example, ‘111 . . . 11’ and generates a second weight detecting signal WMIN when all the bits of the weight signal W are low, for example, ‘000 . . . 00’. The first weight detecting signal (WMAX) and the second weight detecting signal WMIN, along with the first weight control signal WUP and the second weight control signal WDN are input to a selection control signal generator (SCSG) 78, which generates the first selection control signal SUP and the second selection control signal SDN and supplies them to the selection signal generator (SSG) 70.

FIG. 19 illustrates a weight control generator (WCG), for example, weight control generator (WCG) 72 of FIG. 18, in accordance with an example embodiment of the present invention. The weight control generator (WCG) 72 includes an exclusive-OR (XOR) gate, an inverter 11, 2^{S} AND gates, and S OR gates, where S is equal to the number of selection signals. In example embodiments set for the above, S=2, and therefore, the weight control generator (WCG) 72 of FIG. 19 includes four AND gates AND1-AND4, and two OR gates OR1-OR2.

The two selection signals S1, S2 from the control circuit (CC) 581 are exclusive-ORed by the exclusive-OR (XOR) gate and the result is inverted by inverter I1. The output of the exclusive-OR (XOR) gate is input as one input to two of the four AND gates AND1-AND4. The output of inverter I1 is input as one input to the other two of the four AND gates AND1-AND4. The UP signal from phase detector (PD) 56 is also input as one input to two of the four AND gates AND1-AND4. The DOWN signal from phase detector (PD) 56 is input as one input to the other two of the four AND gates AND1-AND4.

The outputs of the four AND gates AND1-AND4 are ORed in the two OR gates OR1-OR2. The output of OR gate OR1 and OR2 are the first weight control signal WUP and the second weight control signal WDN, respectively, and are output to the weight signal generator (WSG) 74 and the selection signal generator (SSG) 70 of FIG. 18.

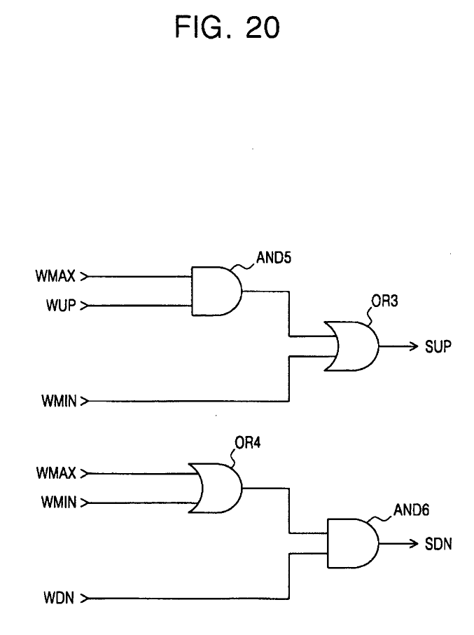

FIG. 20 illustrates a selection control signal generator in accordance with another example embodiment of the present invention, for example, selection control signal generator (SCSG) 78, described above in conjunction with FIG. 18.

The selection control signal generator (SCSG) 78 includes two AND gates AND5-AND6 and two OR gates OR3-OR4. One pair of AND/OR gates, AND5-OR3, receives the first weight detecting signal WMAX and the second weight detecting signal WMIN from the weight minimum/maximum detector (WD) 76 and the first weight control signal WUP from the weight control generator (WCG) 72 and generates a first selection control signal SUP.

The other pair of AND/OR gates, OR4-AND6 receives the first weight detecting signal WMAX and the second weight detecting signal WMIN from the weight minimum/maximum detector (WD) 76 and the second weight control signal WDN from the weight control generator (WCG) 72 and generates a second selection control signal SDN.

The first selection control signal SUP is activated when the first weight detecting signal WMAX and the first weight control signal WUP are enabled or second weight detecting signal WMIN is enabled. The second selection control signal SDN is activated when the first weight detecting signal WMAX and second weight detecting signal WIN are enabled or second weight control signal WDN is enabled. The first selection control signal SUP or the second selection control signal SDN are supplied to the selection signal generator (SSG) 70 of FIG. 18.

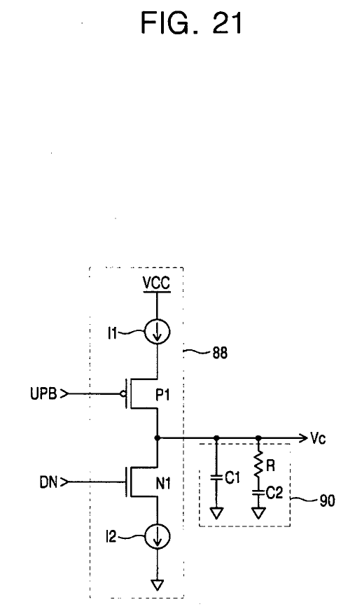

FIG. 21 illustrates a charge pump and a loop filter in accordance with another example embodiment of the present invention, for example, the charge pump 88 and the loop filter 90, described above in conjunction with FIGS. 15A-15B.

The charge pump 88 may include a first current source I1, a second current source I2, a PMOS transistor P1 and an NMOS transistor N1. The loop filter 90 may include a first capacitor C1, a second capacitor C2, and a resistor R.

When an inverted UP signal UPB is activated, an output terminal is charged by the first current source I1 and filtered by loop filter 90 so that the control voltage Vc is increased.

When a DN signal is activated, the output terminal is discharged through the second current source I2 and filtered by low pass filter 90 so that the control voltage Vc is decreased. After completing a locking operation, PMOS transistor P1 and NMOS transistor N1 are turned off so that control voltage Vc maintains the desired voltage value.

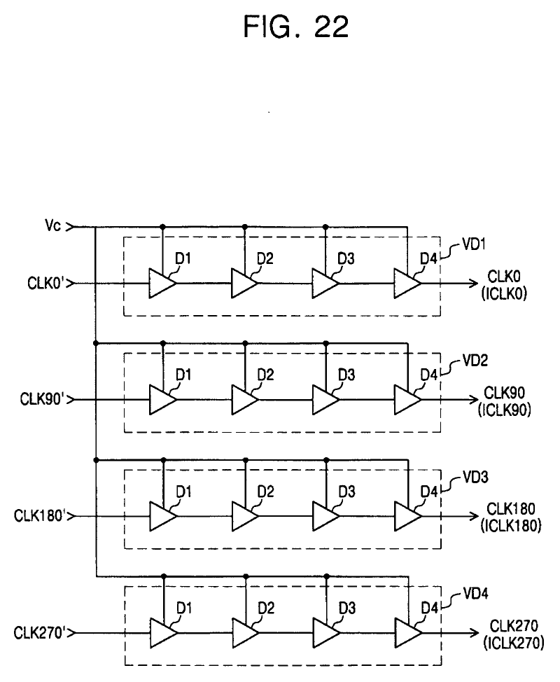

FIG. 22 illustrates a voltage controlled delay line (VCDL) in accordance with another example embodiment of the present invention, for example, the voltage controlled delay line (VCDL) 82, described above in conjunction with FIGS. 15A-15B.

The voltage controlled delay line (VCDL) 82 may include a plurality of variable delay lines VD1-VD4 (for N=4) which each include a plurality of delay cells D1-D4. Each of plurality of variable delay lines VD1-VD4 and each of the plurality of delay cells D1-D4 is controlled by the control voltage Vc. Thus, the first internal clock signals (CLK0′-CLK270′) are delayed for a desired time in response to the control voltage Vc to generate second internal clock signals CLK0-CLK270 or second clock signals ICLK0-ICLK270.

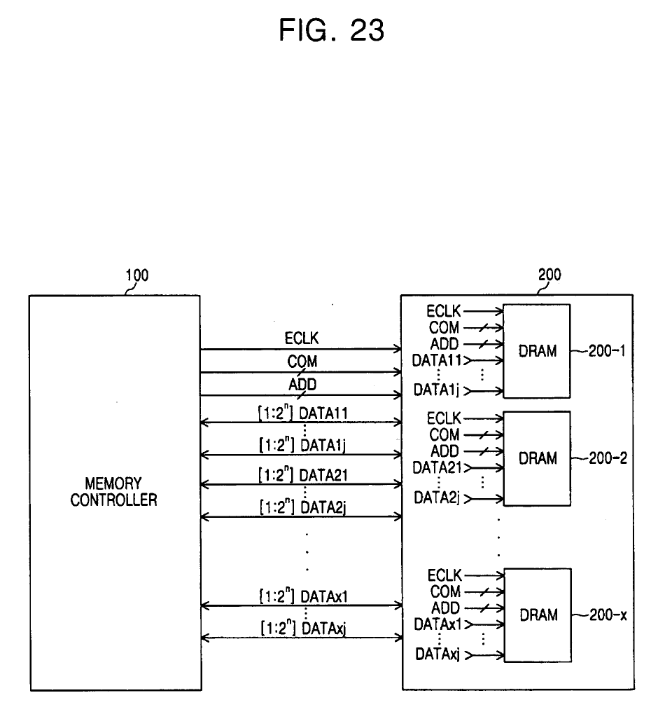

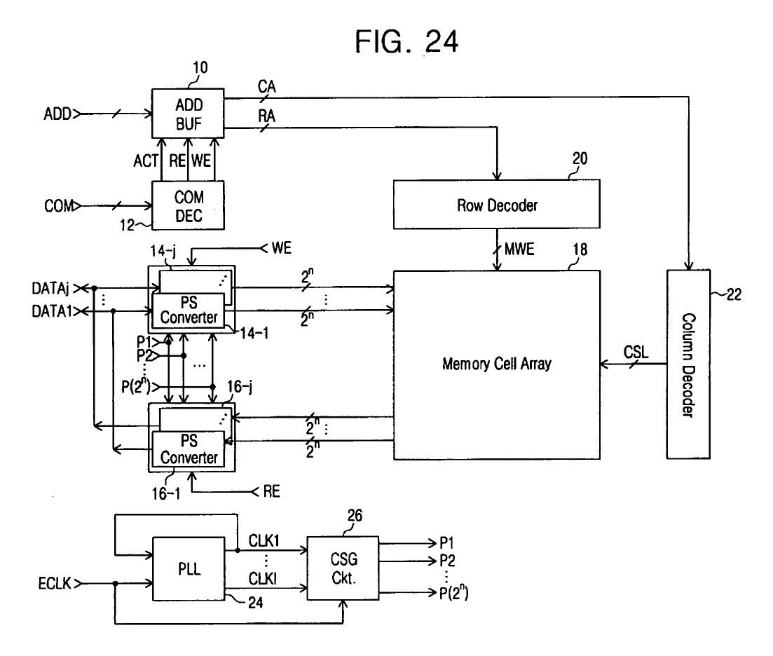

FIG. 23 illustrates an example of a memory system and FIG. 24 illustrates an example of a memory device, for example the memory device 200-1 of FIG. 23, including associated control logic, in accordance with an example embodiment of the present invention. More particularly, the memory module 200 of FIGS. 23 and 24 may include one or more of the multiphase clock generators described above in conjunction with FIGS. 5A-12 as phase locked loop 24.

As shown, a memory system in accordance with an example embodiment of the present invention may include a memory controller 100 and a memory module 200. The memory module 200 may further include a plurality of memory devices 200-1, 200-2, 200-x, which may be implemented, for example, by DRAMs.

The memory controller 100 may output an external clock signal ECLK, one or more command signals COM, one or more address signals ADD, and/or one or more data signals DATA to the memory module 200.

The memory module 200 may also output one or more data signals DATA to the memory controller 100. In the example shown in FIG. 23, the one or more data signals DATA may be composed of a serial stream of 2ⁿ bits, represented by [1:2ⁿ] DATA11 to [1:2ⁿ] DATAxj. As shown in FIG. 23, memory device 200-1 may receive the external clock signal ECLK, the one or more command signals COM, the one or more address signals ADD, and the DATA signals DATA 11 to DATA 1j. Similarly, memory device 200-2 may receive the external clock signal ECLK, the one or more command signals COM, the one or more external address signals ADD, and the DATA signals DATA 21 to DATA 2j, and memory device 200-x may receive the external clock signal ECLK, the one or more command signals COM, the one or more address signals ADD, and the DATA signals DATA x1 to DATA xj.

As shown, in the example memory system of FIG. 23, each memory device 200-1, 200-2, 200-x may receive or output DATA composed of serial 2ⁿ bits during one clock cycle of the external clock signal ECLK. In addition, DATA of j bits may be written or read at the same time.

As shown in FIG. 24, the associated control logic may include an address buffer (ADD BUF) 10, a command decoder (COM DEC) 12, one or more serial-to-parallel converters 14-1 to 14-j (j corresponding to the j in FIG. 1A), one or more parallel-to-serial converters 16-1 to 16-j, the memory cell array 18, a row decoder 20, a column decoder 22, a PLL 24, and/or a control signal generation circuit (CSG Ckt.) 26. The address buffer (ADD BUF) 10 may receive one or more external input addresses (ADD) to generate a row address (RA), supplied to the row decoder 20, in response to an active command signal (ACT).

The row decoder 20 may activate a main word line enable signal (MWE) corresponding to a plurality of row addresses generated from a plurality of row address buffers so that a desired word line (not shown) may be selected in the memory cell array 18. The address buffer (ADD BUF) 10 may also generate a column address (CA), supplied to the column decoder 22, in response to a read command (RE) or a write command (WE) decoded from the one or more command signals COM.

The column decoder 22 may receive a plurality of column addresses to activate a corresponding column select line (CSL). A plurality of bit lines of the memory cell array 18 may be selected in response to the selected CSL so that a plurality of data may be written to or read from the selected memory cells.

As set forth above, the command decoder 12 may generate an active command, a read command and a write command after receiving a plurality of external command signals (COM), for example, RASB, CASB, WEB, etc.

Each serial-to-parallel converter (14-1 to 14-j) may receive serial data DATA composed of 2ⁿ bit data and output 2ⁿ bit parallel data through 2ⁿ data bus lines simultaneously to the memory cell array 18, in response to a write command signal (WE) and a plurality of control signals (P1˜P(2ⁿ)). If the number of data input/data output pins (DQ) is j, the number of serial-to-parallel converter is also j. In addition, each of the serial-to-parallel converters (14-1 to 14-j) may be coupled to the memory cell array 18 via 2ⁿ data bus lines.

Each parallel-to-serial converter (16-1 to 16-j) may receive 2ⁿ bit data from a memory cell array 18 in parallel and output 2ⁿ bit serial data responsive to a read command signal (RE) and the plurality of control signals (P1˜P(2ⁿ)). If the number of data input/data output pins (DQ) is j, the number of parallel-to-serial converters is also j.

The phase lock loop 24 may receive the external clock signal ECLK and perform a locking operation to output an internal clock signal CLK1, which is locked with ECLK. After completing the locking operation, the phase lock loop 24 may output a plurality of internal clock signals (CLK1˜CLKI), which correspond to the N second clock signals ICLKn, described above in conjunction with FIGS. 14A-15B, to the control signal generation circuit (CSG Ckt.) 26. The control signal generation circuit (CSG Ckt.) 26 may generate the plurality of control signals (P1˜P(2ⁿ)).

It will be apparent to those skilled in the art that other changes and modifications may be made in the above-described example embodiments without departing from the scope of the invention herein, and it is intended that all matter contained in the above description shall be interpreted in an illustrative and not a limiting sense.

What is claimed is:

1. A clock generation circuit, comprising:
an inverter directly receiving an external clock signal and outputting an inverted external clock signal;
M (where M is an integer ≧1) loop circuits arranged in series, the first loop circuit receiving the inverted external clock signal, each of the N loop circuits having n (where n is an integer ≧2) nodes, each of the M−1 loop circuits generating n intermediate internal clock signals, each at a corresponding one of the n nodes, wherein a frequency of the n intermediate internal clock signals is a multiple of a frequency of the external clock signal and the inverted external clock signal; and
n sets of inverters, each including M−1 inverters connected in series, each of the M−1 inverters receiving a corresponding intermediate internal clock signal from a previous loop circuit and outputting a corresponding intermediate internal clock signal to a next loop circuit.

2. The clock generation circuit of claim 1, each of n sets of inverters, including M inverters connected in series, the clock generation circuit further comprising:
an (M+1)th loop circuit, in series with the M loop circuits,
the (M+1)th loop circuit having n nodes, each receiving a corresponding intermediate internal clock signal from each of the Mth inverters and generating n internal clock signals, each at a corresponding one of the n nodes.

3. The clock generation circuit of claim 2, wherein each of the (M+1)th loop circuits includes a plurality of loops.

4. The clock generation circuit of claim 2, wherein each of the (M+1)th loop circuits includes a single loop.

5. The clock generation circuit of claim 2, wherein n is selected from the group consisting of 4, 5, 6, 8, 9, 10, 12, 15, and 18.

6. The clock generation circuit of claim 1, each of n sets of inverters, including M inverters connected in series, the clock generation circuit further comprising:
an (M+1)th loop circuit and;
an (M+2)th loop circuit and an (M+2)th set of inverters,
the (M+1)th loop circuit and the (M+2)th loop circuit in series with the M loop circuits and in parallel with each other,
the (M+1)th loop circuit having n nodes, some receiving a corresponding intermediate internal clock signals from the Mth inverters;
the (M+2)th loop circuit having n nodes, some receiving a corresponding intermediate internal clock signals from the Mth inverters generating n internal clock signals, each at a corresponding one of the n nodes
a first group of n inverters, each receiving a corresponding intermediate internal clock signal from the (M+1)th loop circuit;
a second group of n inverters, each receiving a corresponding intermediate internal clock signal from the (M+2)th loop circuit; and
a third group of n inverters, each receiving outputs from the corresponding inverters from the first group of n inverters and the second group of n inverters and generating n internal clock signals.

7. The clock generation circuit of claim 6, wherein each of the (M+1)th loop circuits includes a plurality of loops.

8. The clock generation circuit of claim 6, wherein each of the (M+1)th loop circuits includes a single loop.

9. The clock generation circuit of claim 6, wherein n is selected from the group consisting of 4, 5, 6, 8, 9, 10, 12, 15, and 18.

10. A multiphase clock generator including the clock generation circuit of claim 1.

11. The multiphase clock generator of claim 10, further comprising:
a phase detector receiving the external clock signal and a feedback clock signal and outputting an up signal when a phase of the external clock signal leads a phase of the feedback clock signal and outputting a down signal when the phase of the external clock signal lags the phase of the feedback clock signal.

12. The multiphase clock generator of claim 11, further comprising:
a control signal generator receiving the up signal and the down signal from the phase detector and outputting at least one control signal; and
a phase modifying circuit receiving the at least one control signal and the n intermediate internal clock signal output from the Mth loop circuit as n first internal clock signals to generate n second clock signals, the phase modifying circuit outputting at least one of the n second clock signals as the feedback clock signal.

13. The multiphase clock generator of claim 12, wherein the control signal generator is a loop filter circuit including a charge pump and a low pass filter and the at least one control signal includes a control voltage, the charge pump charging or discharging the low pass filter to control a level of the control voltage until a locking operation is completed.

14. The multiphase clock generator of claim 13, wherein the phase modifying circuit is a voltage controlled delay line including a plurality of variable delay lines, each including a plurality of delay cells, each controlled by the control voltage Vc, the voltage controlled delay line delaying the n first internal clock signals in response to the control voltage to generate n second clock signals.

15. The multiphase clock generator of claim 13, wherein the phase modifying circuit includes
a voltage controlled delay line including a plurality of variable delay lines, each including a plurality of delay cells, each controlled by the control voltage Vc, the voltage controlled delay line delaying the n first internal clock signals in response to the control voltage to generate n second internal clock signals;
a multiplier multiplying a frequency of the n second internal clock signals to generate n second clock signals having a frequency higher than a frequency of the n second internal clock signals; and
a divider, dividing a frequency of at least one of the n second clock signals to generate the feedback clock signal.

16. The multiphase clock generator of claim 12, wherein the control signal generator is a control circuit and the at least one control signal includes a plurality of selection signals and a weight signal.

17. The multiphase clock generator of claim 16, wherein the phase modifying circuit is a selection and phase interpolation circuit receiving the n first internal clock signals, selecting two of the n first internal clock signals in response to control signals, interpolating phases of the selected two of the n first internal clock signals in response to a weight signal to generate n second clock signals, synchronized with the external clock signal and outputting at least one of the n second clock signals as the feedback clock signal.

18. The multiphase clock generator of claim 16, wherein the phase modifying circuit includes
a selection and phase interpolation circuit receiving the n first internal clock signals, selecting two of the n first internal clock signals in response to control signals, interpolating phases of the selected two of the n first internal clock signals in response to a weight signal to generate n second internal clock signals;
a multiplier multiplying a frequency of the n second internal clock signals to generate n second clock signals having a frequency higher than a frequency of the n second internal clock signals; and
a divider, dividing a frequency of at least one of the n second clock signals to generate the feedback clock signal.

19. The multiphase clock generator of claim 12, wherein the phase modifying circuit is a voltage controlled delay line including a plurality of variable delay lines, each including a plurality of delay cells, each controlled by the control voltage Vc, the voltage controlled delay line delaying the n first internal clock signals in response to the control voltage to generate n second clock signals.

20. The multiphase clock generator of claim 12, wherein the phase modifying circuit is a selection and phase interpolation circuit receiving the n first internal clock signals, selecting two of the n first internal clock signals in response to control signals, interpolating phases of the selected two of the n first internal clock signals in response to a weight signal to generate n second clock signals, synchronized with the external clock signal and outputting at least one of the n second clock signals as the feedback clock signal.

21. The multiphase clock generator of claim 11, wherein the phase detector includes
a first flip-flop receiving the external clock signal, a return signal, and a voltage Vcc and outputting the up signal;
a second flip-flop receiving the feedback clock signal, the return signal and the voltage Vcc and outputting the down signal; and
a NAND gate for NANDing the up signal and the down signal to generate the return signal.

22. The multiphase clock generator of claim 11, wherein the up signal and the down signal are used to control a phase of the corresponding intermediate internal clock signals.

23. The multiphase clock generator of claim 20, wherein the selection and phase interpolation circuit selects and interpolated among adjacent clock signals.

24. The multiphase clock generator of claim 20, wherein the at least one control signal includes a plurality of selection signals and a weight signal, the selection and phase interpolation circuit including
a plurality of selection circuits, each receiving a corresponding one of the plurality of selection signals, and at least two of the n first internal clock signals; and
a phase interpolation circuit receiving an output of each of the plurality of selection circuits and outputting second clock signals in response to the weight signal.

25. The multiphase clock generator of claim 16, wherein the control circuit includes
a selection signal generator performing an UP counting operation in response to a first selection control signal SUP and performs a down counting operation in response to second selection control signal SDN;
a weight control generator generating a first weight control signal WUP and a second weight control signal WDN;
a weight signal generator performing up counting operation in response to the first weight control signal WUP signal and performs down counting operation in response to the second weight control signal WDN, and outputs the weight signal W;
a weight minimum/maximum detector detecting a maximum value of the weight signal W and generating a first weight detecting signal (WMAX) and detecting a minimum value of the weight signal W and generating a second weight detecting signal (WMIN); and
a selection control signal generator receiving the first weight detecting signal (WMAX), the second weight detecting signal WMIN, the first weight control signal WUP, and the second weight control signal WDN and generating the first selection control signal SUP and the second selection control signal SDN, supplied to the selection signal generator.

26. The multiphase clock generator of claim 16, wherein the control circuit receives the up signal and the down signal from a phase detector and generates the plurality of selection signal and the weight signal.

27. The multiphase clock generator of claim 25, wherein the weight control generator includes
an exclusive-OR (XOR) gate for exclusive-ORing S (S≧1) selection signals,
an inverter 11 for inverting an output of the exclusive-OR (XOR) gate,
2^{S} AND gates, a portion receiving an output of the exclusive-OR (XOR) gate and a remainder receiving an output of the inverter and a portion receiving up signal and a remainder receiving a down signal, and
S OR gates, ORing outputs of the 2^{S} AND gates to generate the first weight control signal WUP and the second weight control signal WDN.

28. The multiphase clock generator of claim 25, wherein the selection control signal generator includes
at least two AND/OR gate pairs,
a first receiving the first weight detecting signal WMAX and the second weight detecting signal WMIN from the weight minimum/maximum detector (WD) and the first weight control signal WUP from the weight control generator (WCG) and generates the first selection control signal SUP and
a second receiving the first weight detecting signal WMAX and the second weight detecting signal WMIN from the weight minimum/maximum detector (WD) 76 and the second weight control signal WDN from the weight control generator (WCG) and generates the second selection control signal SDN.

29. The multiphase clock generator of claim 13, wherein the charge pump/low pass filter includes
a first current source, a second current source, a PMOS transistor and an NMOS transistor in series and
a first capacitor and a second capacitor/resistor pair in parallel, wherein when
an inverted UP signal UPB is supplied to a gate of the PMOS transistor P1, an output terminal is charged by the first current source I1 and filtered by the loop filter so that the control voltage Vc is increased and when
a DN signal is activated, the output terminal is discharged through the second current source and filtered by the low pass filter so that the control voltage Vc is decreased.

30. A memory device comprising:
a memory cell array;
a multiphase clock generator receiving an external clock signal and a feedback clock signal and comprising at least a clock generator circuit directly generating at least n (where n is an integer ≧2) internal clock signals;
a control signal generator circuit for receiving the at least n internal clock signals and generating p control signals (where p is an integer ≧2);
at least one serial to parallel converter, for receiving a serial bit stream bits and converting the serial bit stream into a parallel bit stream that can be written to the memory cell array, in response to each of the p control signals; and
at least one parallel to serial converter, for receiving a parallel bit stream from the memory cell array and converting the parallel bit stream into a serial bit stream, in response to each of the p control signals.

31. A method of generating n internal clock signals (where n is an integer ≧2), comprising:
directly receiving an external clock signal and inverting the external clock signal;
generating n intermediate internal clock signals from the inverted external clock signal;
phase interpolating the n intermediate internal clock signals M times (where M is an integer ≧1) to generate the n internal clock signals.

32. A method of locking the phase of a feedback clock signal to an external clock signal, comprising:
receiving the external clock signal and the feedback clock signal;
outputting an up signal when a phase of the external clock signal leads a phase of the feedback clock signal and outputting a down signal when the phase of the external clock signal lags the phase of the feedback clock signal;
generating at least one control signal in response to the up signal and the down signal; and
directly generating at least n (where n is an integer ≧4) internal clock signals, the at least one control signal controlling a phase change of at least one of the n internal clock signals; and
generating the feedback clock signal from at least one of the n internal clock signals.
